(19) United States
(12) Patent Application Publication
(10) Pub. No.: US 2019/0174462 A1
(43) Pub. Date: Jun. 6, 2019

(54) USER TERMINAL AND RADIO COMMUNICATION METHOD

(71) Applicant: NTT DOCOMO, INC., Tokyo (JP)

(72) Inventors: Hiroki Harada, Tokyo (JP); Kazuki Takeda, Tokyo (JP); Satoshi Nagata, Tokyo (JP); Jiahui Liu, Beijing (CN); Qin Mu, Beijing (CN); Lihui Wang, Beijing (CN); Liu Liu, Beijing (CN); Huiling Jiang, Beijing (CN)

(73) Assignee: NTT DOCOMO, INC., Tokyo (JP)

(21) Appl. No.: 16/324,188

(22) PCT Filed: Aug. 8, 2017
(86) PCT No.: PCT/JP2017/028799

§ 371 Date: Feb. 8, 2019

(30) Foreign Application Priority Data
Aug. 10, 2016 (JP) 2016-157993

(51) Int. Cl. H04W 72/00; H04W 48/10

(52) U.S. Cl. CPC H04W 72/005; H04W 48/10

(57) ABSTRACT

The present invention is designed to transmit and/or receive system information properly in a radio communication system where multiple numerologies are configured. A user terminal communicates in a radio communication system where multiple numerologies are configured, and this user terminal has a receiving section that receives system information of each of the numerologies via at least one broadcast channel, and a control section that controls reception of the broadcast channel, and the control section controls reception of the broadcast channel that is transmitted in each of the numerologies or that is transmitted selectively in a given numerology.

### TECHNICAL FIELD

The present invention relates to a user terminal and a radio communication method in next-generation mobile communication systems.

### BACKGROUND ART

In the UMTS (Universal Mobile Telecommunications System) network, the specifications of long-term evolution (LTE) have been drafted for the purpose of further increasing high speed data rates, providing lower latency and so on (see non-patent literature 1). In addition, successor systems of LTE are also under study for the purpose of achieving further broadbandization and increased speed beyond LTE (referred to as, for example, “LTE-A (LTE-Advanced),” “FRA (Future Radio Access),” “4G,” “5G,” “5G+(plus),” “NR (New RAT),” “LTE Rel. 14,” “LTE Rel. 15 (or later versions),” and so on).

In existing LTE systems (for example, LTE Rel. 10 and later versions), carrier aggregation (CA), in which multiple carriers (component carriers (CCs), cells, etc.) are integrated, is introduced in order to achieve broadbandization. Every carrier is formed using the system bandwidth of LTE Rel. 8 as one unit. In addition, in CA, multiple CCs under the same radio base station (eNB (eNodeB)) are configured in a user terminal (UE (User Equipment)).

Also, in existing LTE systems (for example, LTE Rel. 12 and later versions), dual connectivity (DC), in which multiple cell groups (CGs) formed by different radio base stations are configured in a user terminal, is also introduced. Every cell group is comprised of at least one cell (CC, cell, etc.). In DC, multiple CCs of different radio base stations are integrated, so that DC is also referred to as “inter-eNB CA.”

Also, in existing LTE systems (for example, LTE Rel. 8 to 13), downlink (DL) communication and/or uplink (UL) communication are carried out by using 1-ms transmission time intervals (TTIs) (also referred to as “subframes” and so on). This 1-ms TTI is the unit of time it takes to transmit one channel-encoded data packet, and serves as the processing unit in scheduling, link adaptation and so on.

### CITATION LIST

### Non-Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall description; Stage 2”

### SUMMARY OF INVENTION

### Technical Problem

There is an expectation that future radio communication systems (for example, 5G, NR, etc.) will accommodate various services such as high-speed and large-capacity communication (eMBB (enhanced Mobile Broad Band)), massive access (mMTC (massive MTC)) from devices (user terminals) for machine-to-machine communication (M2M) such as IoT (Internet of Things) and MTC (Machine-Type Communication), and low-latency, reliable communication (URLLC (Ultra-Reliable and Low Latency Communication)), in a single framework.

In this way, there is a likelihood that a plurality of services with different requirements for latency reduction will be co-present in future radio communication systems. For example, a user terminal might use a plurality of services (different numerologies), depending on in what manner the user terminal is used. Also, future radio communication systems are under investigation to multiplex a number of user terminals that use (or support) different numerologies, in the same carrier (CC, cell, etc.).

Here, “numerology” refers to communication parameters that are defined in the frequency direction and/or the time direction (for example, at least one of the subcarrier spacing, the bandwidth, the duration of symbols, the time duration of CPs (CP duration), the duration of subframes, the time duration of TTIs (TTI duration), the number of symbols per TTI, the radio frame structure, the filtering process, the windowing process, and so on).

Meanwhile, when a user terminal communicates by using at least one of different frame structures of varying numerologies, how to control communication is the problem. For example, when a user terminal communicates using a number of numerologies, the user terminal needs to learn system information corresponding to respective numerologies. In this case, a method to allow the user terminal to properly receive this system information and/or others is required.

The present invention has been made in view of the above, and it is therefore an object of the present invention to provide a user terminal and a radio communication method, whereby system information can be transmitted and/or received properly in a radio communication system in which a plurality of numerologies are configured.

### Solution to Problem

A user terminal according to one aspect of the present invention communicates in a radio communication system where multiple numerologies are configured, and this user terminal has a receiving section that receives system information of each of the numerologies via at least one broadcast channel, and a control section that controls reception of the broadcast channel, and the control section controls reception of the broadcast channel that is transmitted in each of the numerologies or that is transmitted selectively in a given numerology.

### Advantageous Effects of Invention

According to the present invention, system information can be transmitted and/or received properly in a radio communication system where a plurality of numerologies are configured.

### BRIEF DESCRIPTION OF DRAWINGS

FIG. 1 is a diagram to explain problems with methods of transmitting MIBs of respective numerologies;

FIG. 2 is a diagram to show an example of the method of transmitting MIBs in a number of numerologies;

FIG. 3 is a diagram to show an example of a table in which bandwidths (NR BWs) and offsets between numerologies are set forth;

FIG. 4 is a diagram to show an example of a table in which offsets between numerologies are set forth;

FIG. 5A shows an example of a table in which offsets between numerologies are set forth, and FIG. 5B is a diagram to show an example of the method of transmitting MIBs in a number of numerologies;

FIG. 6 is a diagram to show another example of the method of transmitting MIBs in a number of numerologies;

FIG. 7 is a diagram to show another example of the method of transmitting MIBs in a number of numerologies;

FIG. 8 is a diagram to show another example of the method of transmitting MIBs in a number of numerologies;

FIG. 9 is a diagram to show another example of the method of transmitting MIBs in a number of numerologies;

FIG. 10 is a diagram to show another example of the method of transmitting MIBs in a number of numerologies;

FIG. 11 is a diagram to show another example of the method of transmitting MIBs in a number of numerologies;

FIG. 12 is a diagram to show an example of a schematic structure of a radio communication system according to an embodiment of the present invention;

FIG. 13 is a diagram to show an example of an overall structure of a radio base station according to an embodiment of the present invention;

FIG. 14 is a diagram to show an example of a functional structure of a radio base station according to one embodiment of the present invention;

FIG. 15 is a diagram to show an example of an overall structure of a user terminal according to an embodiment of the present invention;

FIG. 16 is a diagram to show an example of a functional structure of a user terminal according to an embodiment of the present invention; and

FIG. 17 is a diagram to show an example hardware structure of a radio base station and a user terminal according to an embodiment of the present invention.

### DESCRIPTION OF EMBODIMENTS

To provide an access scheme for use in new future communication systems (which may be referred to as “5G RAT,” “new RAT,” and so on), one that enhances the access scheme used in existing LTE/LTE-A systems (which may be referred to as “LTE RAT,” “LTE-based RAT,” and so on) is under investigation.

In 5G RAT, a radio frame and/or a subframe structure that are different from those of LTE RAT may be used. For example, a radio frame structure, in which at least one of the duration of subframes, the duration of symbols, the subcarrier spacing and the system bandwidth is different from existing LTE (LTE Rel. 8 to 12), may be used as a radio frame structure for 5G RAT.

Note that a subframe may be referred to as a “transmission time interval (TTI).” For example, the duration of a TTI (subframe) according to LTE Rel. 8 to 12 is 1 ms, comprised of two time slots. A TTI is the unit of time it takes to transmit a channel-encoded data packet (transport block), and serves as the processing unit in scheduling, link adaptation and so on.

To be more specific, while 5G RAT stipulates new radio parameters, for example, the method of using communication parameters that define LTE radio frames (for example, the subcarrier spacing, the bandwidth, the duration of symbols, and so forth) by multiplying these parameters by constants (for example, by N, 1/N and so on) depending on LTE RAT numerologies, is also under study. Note that a “numerology” refers to a set of communication parameters that characterize the design of signals in a given RAT and/or the design of the RAT. Note that multiple numerologies may be defined and used in one RAT.

Also, when multiple numerologies vary, this means that, for example, at least one of following (1) to (6) varies, but this is by no means limiting: (1) the subcarrier spacing; (2) the duration of CPs (Cyclic Prefixes); (3) the duration of symbols; (4) the number of symbols per TTI; (5) the duration of TTIs; and (6) the filtering process, the windowing process, and/or other processes.

5G RAT (NR) is planned to target a very wide range of frequencies (for example, 1 GHz to 100 GHz) for use as carrier frequencies, so that a number of numerologies with different symbol durations, subcarrier spacing and so on may be co-present and supported depending on the requirements for each use. To provide a number of examples of numerologies to be employed in 5G RAT, a structure may be employed, in which, based on LTE RAT, the subcarrier spacing, the bandwidth and so on are multiplied by N (for example, N>1), and the symbol duration is multiplied by 1/N.

Now, in existing LTE systems, a user terminal receives system information (broadcast information), which is required in downlink communication through, for example, the MIB (Master Information Block), which is transmitted in a broadcast channel (PBCH). The MIB is transmitted in a 1.4-MHz center band (six RBs in the center), in subframe #0 of each radio frame, in a cycle of 10 msec.

The MIB contains information that is necessary to receive the downlink (the downlink bandwidth, the downlink control channel structure, the system frame number (SFN) and so on). A user terminal controls receipt of SIBs (System Information Blocks), which are communicated in a downlink shared data channel (PDSCH), based on the MIB. The location where the MIB is allocated is fixed—that is, a fixed time resource and frequency resource. Thus, the MIB is transmitted from a radio base station in fixed resources, and therefore can be received without sending a special notice to the user terminal.

Now, by contrast with this, when a number of numerologies are configured in a 5G RAT carrier (NR carrier), the system information (for example, the system frame number and/or the subframe index) might vary between different numerologies. In addition, information regarding PRACH configuration may vary between different numerologies. At the same time, however, common information may be used between different numerologies. In this case, pieces of system information that correspond to numerologies and/or others may be included in the MIB and transmitted via a broadcast channel, but the problem lies in how to transmit the system information of each numerology.

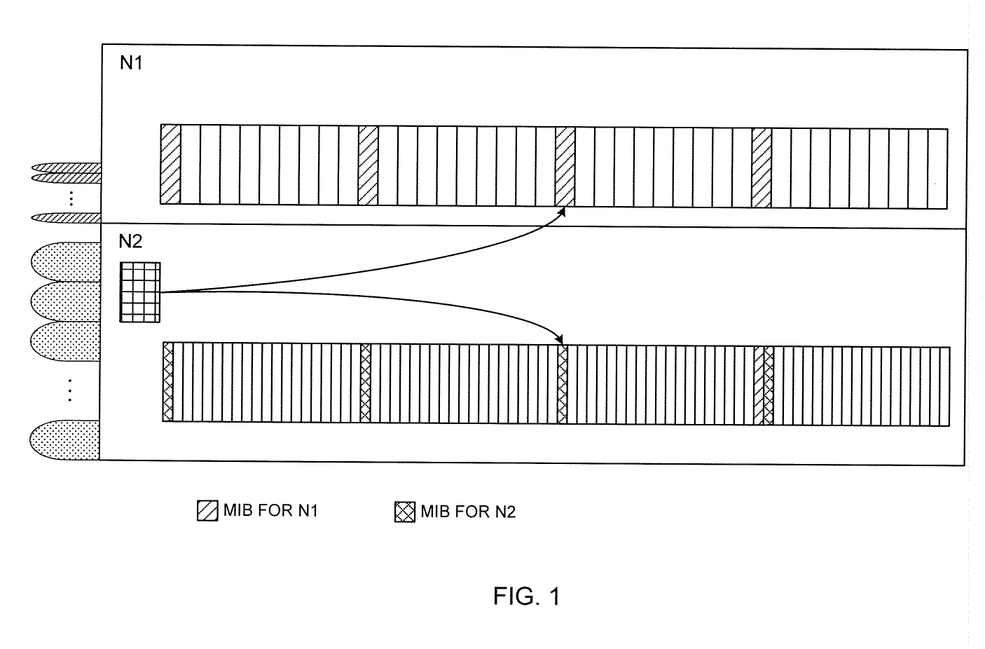

FIG. 1 shows a case in which a broadcast channel for transmitting the MIB is configured in each different numerology (here, N1 and N2). The problem in this case has to do with the method of transmitting system information (MIB) (the method of detection in user terminals), how to control the contents of system information (MIB) that is transmitted, and so on.

So, the present inventors have come up with the idea of using a method of controlling transmission and receipt of system information that corresponds to a number of numerologies, separately, on a per numerology basis, or controlling transmission and receipt of system information that corresponds to a number of numerologies by combining these numerologies. To be more specific, pieces of system information (for example, contents of MIBs) that correspond to respective numerologies are configured separately, and transmission and receipt are controlled accordingly. Alternatively, transmission and receipt are controlled by combining pieces of system information (for example, contents of MIBs) that correspond to respective numerologies.

Now, embodiments of the present invention will be described below detail. In the following description, three different numerologies (N1, N2 and N3) will be primarily described as examples, but the number of numerologies that are applicable is not limited to this. Furthermore, although methods for transmitting and receiving system information/broadcast information (MIB) will be explained in the following description, the MIB is by no means the only signal to which the present embodiment can be applied. Any information that is configured differently per numerology is likewise applicable. Also, as for the information to be contained in the MIB, contents that have been carried in the MIB heretofore may be included, in addition to the information that will be described below. In addition, a number of examples that will be described below may be implemented individually or in appropriate combinations.

(First Aspect)

In accordance with a first aspect of the present invention, an example case will be described below, in which transmission and receipt of broadcast channels (MIBs) are controlled by configuring system information or broadcast information (contents of MIBs) separately, on a per numerology basis. Also, a case will be described below, with the first aspect, where a user terminal controls receipt of MIBs that are configured separately (and that are also referred to as “target MIBs” and so on) based on a predetermined MIB (also referred to as an “anchor MIB,” an “anchor/broadcast channel” and so on).

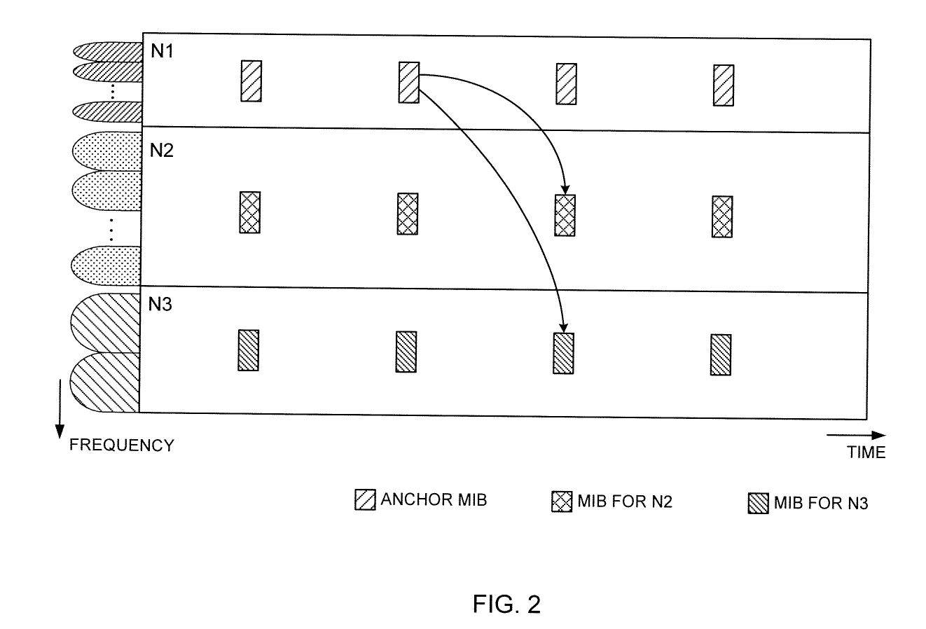

FIG. 2 illustrates a case where, based on an anchor MIB (anchor broadcast channel) that is transmitted in a given numerology (here, N1), a user terminal receives MIBs of other numerologies (here, N2 and N3). The anchor MIB contains the information (assist information) for detecting the MIBs of the other numerologies. Also, the anchor MIB may contain system information corresponding to an anchor numerology (N1) as well. That is, the numerology in which the anchor MIB is transmitted may be referred to as the “anchor numerology.”

For example, after the user terminal receives a synchronization signal transmitted from the radio base station and establishes synchronization, the user terminal then receives the anchor MIB, which is transmitted in the anchor numerology. As for the method by which the user terminal identifies the anchor numerology, it is possible to use the method of determining the anchor numerology in advance, or use the method of identifying the anchor numerology based on a predetermined signal (for example, a synchronization signal).

For example, if a synchronization signal is configured in common in a number of numerologies (shared SS design), the user terminal identifies the numerology, in which this synchronization signal, configured on a shared basis (shared synchronization signal), is transmitted, as being the anchor numerology. That is, the user terminal can learn the anchor numerology by performing the receiving process (including, for example, blind detection) for a synchronization signal.

If separate synchronization signals are configured for each of multiple numerologies (separate SS design), a predetermined numerology may be designated the anchor numerology in advance. In this case, regardless of in which numerology a synchronization signal is detected, the user terminal is able to identify the anchor numerology. The anchor numerology may be, for example, a numerology to use a certain subcarrier spacing (for example, 15 kHz) can be used.

The location (the frequency and/or the time resource) of the anchor MIB, transmitted in the anchor numerology, may be determined in advance. Alternatively, the location of the anchor MIB may be identified based on a predetermined signal. For example, it is possible to employ a structure, in which the anchor MIB is placed in a location that is a predetermined offset (for example, a frequency and/or time resource offset) apart from the location of a synchronization signal (for example, a synchronization signal of the anchor numerology). The user terminal can receive the anchor MIB based on the synchronization signal received.

The user terminal selects at least one of the numerologies the user terminal supports, and controls communication accordingly. For example, if the user terminal supports only the anchor numerology among multiple numerologies, the user terminal detects the MIB (anchor MIB) based on this anchor numerology, and acquires the system information corresponding to that anchor numerology.

If the user terminal supports multiple numerologies, the user terminal can select a predetermined number, M (for example, M (≥1)), of numerologies as communicating numerologies (target numerologies). The user terminal might determine the predetermined number M and M target numerologies, autonomously, based on the user terminal's capabilities and so on, or determine these based on commands from the radio base station. Alternatively, the user terminal may select M target numerologies based on rules that are set forth in advance (or based on a selection table).

In the event the radio base station designates which numerologies are available for use by the user terminal (target numerologies), the radio base station reports information about the priorities of numerologies to the user terminal. This information about the priorities of numerologies can be included in the anchor MIB and/or in SIBs transmitted in the anchor numerology, and so on, and reported to the user terminal. Based on the information concerning the priorities of numerologies, the user terminal selects M target numerologies of higher priorities (including, for example, one with the highest priority), among the numerologies the user terminal supports.

The user terminal receives MIBs that correspond to the target numerologies selected (target MIBs). The target MIBs (target broadcast channels) can be received based on the anchor MIB. For example, the user terminal controls receipt of a target MIB based on the offset that is configured in advance between the anchor MIB and the target MIB. In this case, the offset between the anchor MIB and the target MIB may be determined in advance.

Now, the method by which the user terminal receives target MIBs that correspond to target numerologies for use in communication will be described below.

(Method 1)

First, the user terminal receives an anchor MIB, which is transmitted in an anchor numerology. The radio base station includes information that designates predetermined numerologies (target numerologies) in the anchor MIB, and reports this anchor MIB to the user terminal. For example, the radio base station reports information that designates target numerologies, to the user terminal, by using predetermined bits (for example, two bits).

These two bits are configured so that, for example, a numerology with a subcarrier spacing of 15 KHz (for example, N1) and a numerology of 30 KHz (N2) are “00,” a numerology with a subcarrier spacing of 15 KHz (for example, N1) and a numerology of 60 KHz (N3) are “01,” and a numerology with a subcarrier spacing of 15 KHz (for example, N1), a numerology of 30 KHz (for example, N2) and a numerology of 60 KHz (N3) are “10” (and “11” is reserved). The user terminal can determine in which numerologies target MIBs are received, based on what bit value is provided in the anchor MIB.

Alternatively, information about target numerologies may be reported to the user terminal in the form of bitmap (for example, a three-bit bitmap corresponding to N1 to N3).

After target numerologies are determined, the user terminal receives target MIBs based on offsets that are configured between the target numerologies and the anchor numerology (anchor MIB). The offsets that are configured between the anchor MIB of the anchor numerology (here, N1) and the target MIBs can be determined based on a table that is provided in advance.

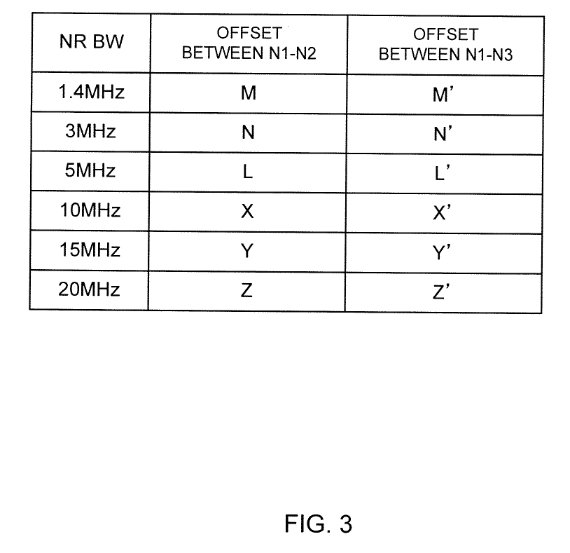

Offsets between an anchor MIB and target MIBs can be configured separately per bandwidth where multiple numerologies are accommodated (for example, the whole bandwidth in which multiple numerologies are configured). FIG. 3 shows an example of a table, in which offsets are configured between an anchor MIB and target MIBs based on how long the bandwidth (NR BW) where a number of numerologies are configured is. For example, in the event the NR BR is 1.4 MHz, the offset between N1 (anchor MIB) and N2 (MIB for N2) is M. Meanwhile, the offset between N1 (anchor MIB) and N3 (MIB for N3) is M′. Note that the offsets in FIG. 3 may be offsets in the frequency direction (frequency resource offsets), and can be configured in units of PRBs and/or REs. Note that offsets in the time direction may be defined in the table as well, or the offsets in the time direction may be configured to zero.

Information about the bandwidth (NR BW) where multiple numerologies are configured can be included in the anchor MIB and so on, and reported from the radio base station to the user terminal. For example, a predetermined bandwidth (for example, one of 1.4 MHz, 3 MHz, 5 MHz, 10 MHz, 15 MHz and 20 MHz) may be reported to the user terminal by using three bits. Obviously, the bandwidth and the number of bits to apply are not limited to these, and can be changed as appropriate. Alternatively, information about the bandwidth corresponding to respective numerologies may be included and reported in the anchor MIB.

The user terminal can receive target MIBs based on information contained in the anchor MIB, the table of FIG. 3, and so on.

(Method 2)

With method 2, a case of using a different table from the table of method 1 (FIG. 3) will be described. Note that the configurations of method 1, except for the table used, can be applied here.

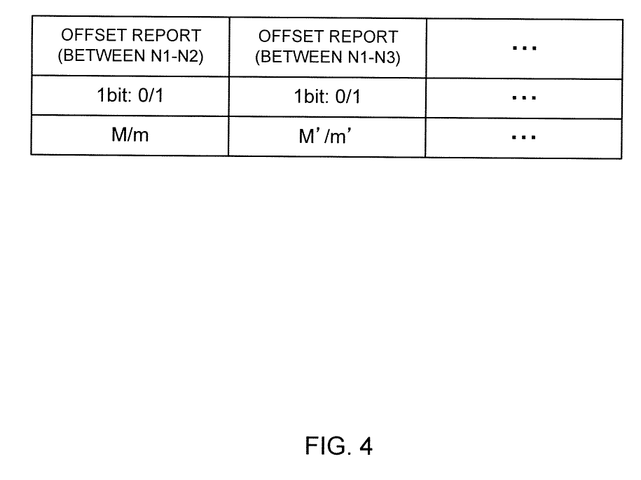

FIG. 4 is a table, showing offsets configured between numerologies. Here, a case is shown where, for each target numerology, offsets are configured separately between an anchor MIB and a target MIB, by using one bit.

To be more specific, in the event the bit value “0” is given, the offset between N2 (target MIB) and N1 (anchor MIB) is M, and, when the bit value is “1,” the offset between N2 and N1 is m. Similarly, in the event the bit value “0” is given, the offset between N3 and N1 is M′, and, when the bit value is “1,” the offset between N3 and N1 is m′. That is, in FIG. 4, the offset between an anchor MIB and a target MIB under two conditions (for example, in two types of bandwidths) can be reported to the user terminal by using one bit.

The radio base station reports predetermined bit values to the user terminal based on the target numerologies configured in the user terminal, and so forth. Note that, when one bit is reported as shown in FIG. 4, two offsets can be configured per target numerology, and, to configure more than two offsets, the number of bits has to be simply increased.

(Method 3)

The user terminal receives an anchor MIB, which is transmitted in an anchor numerology. The radio base station includes information that designates target numerologies and information related to the bandwidth (NR BW) where multiple numerologies are configured, in the anchor MIB, and reports this to the user terminal.

For example, the radio base station reports information about the whole bandwidth (NR BW) where multiple numerologies are configured, to the user terminal, by using predetermined bits (for example, three bits). In addition, the radio base station reports information that designates target numerologies, to the user terminal, by using predetermined bits (for example, two bits). The method of reporting these to the user terminal may be the same as methods 1 and 2 described above.

In addition, the radio base station reports information about the configuration of each numerology (for example information about the ratio of each numerology in the bandwidth) to the user terminal. If the configuration (for example, allocation location) of the broadcast channel configured in each numerology is determined in advance, the user terminal can detect target MIBs based on information about the total bandwidth where a number of numerologies are configured and the ratio of each numerology in the bandwidth.

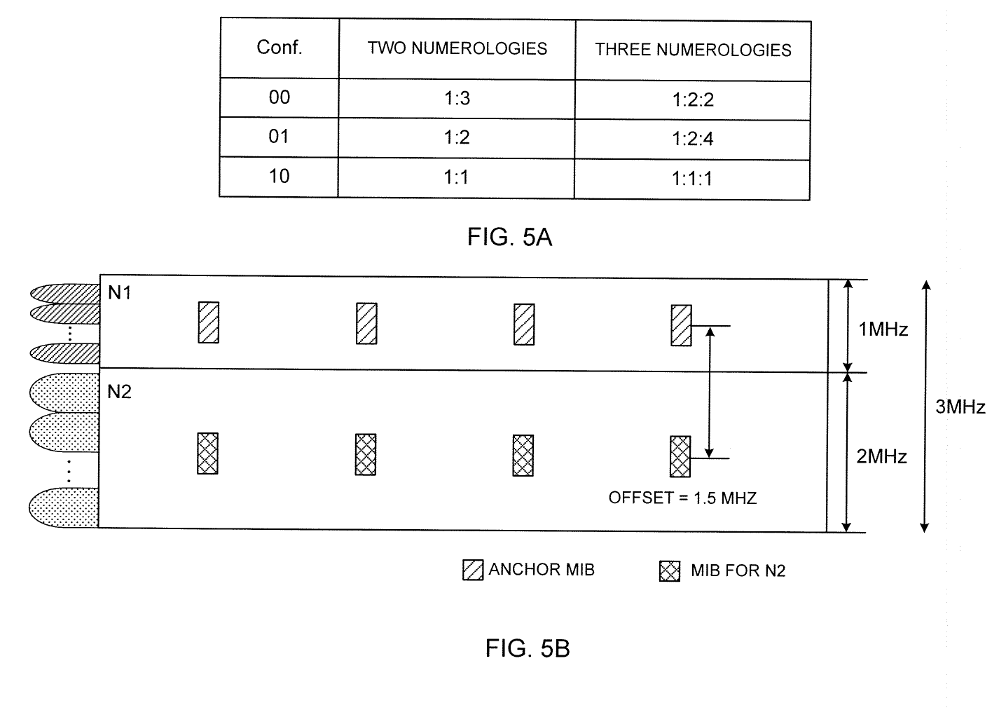

The ratio of each numerology in the bandwidth may be determined in advance in a table and reported to the user terminal in the form of predetermined bit values (see FIG. 5A). FIG. 5A shows a case where two numerologies are configured and a case wherethree numerologies are configured, and shows the ratio of each numerology's bandwidth. For example, the bit value “00” corresponds to the case where the ratio of the bandwidths of two numerologies (for example, N1 and N2) is 1:3, or the case where the ratio of the bandwidths of three numerologies (for example, N1, N2 and N3) is 1:2:2.

Assume the case where two numerologies (for example, N1 and N2) are present, and where it is determined in advance that the MIB is transmitted in the central PRB among the PRBs that constitute each numerology. In this case, the radio base station reports, to the user terminal, that the NR BR is 3 MHz, N1 and N2 are the target numerologies and the numerology configuration is 1:2 (the bit value “01”), the user terminal can judge that the bandwidth of N1 is 1 MHz and the bandwidth of N2 is 2 MHz, and that the offset between the anchor MIB and the target MIBs is 1.5 MHz (see FIG. 5B). Thus, the user terminal can receive the MIBs of the target numerologies, based on the anchor MIB.

Next, examples of system information (contents of MIBs) to be included in the anchor MIB and other MIBs (target MIBs) will be described.

<SFN/Subframe Index>

When a common system frame number (SFN) and/or a subframe index is used between different numerologies, information about this shared SFN and/or subframe index can be included in the anchor MIB. From the shared information contained in the anchor MIB, the user terminal can learn the SFN and/or the subframe index applied to each numerology in common.

When a unique SFN and/or subframe index is used per numerology (assuming that at least one numerology is used), the MIB (target MIB) corresponding to respective numerologies can contain information about its SFN and/or subframe index. In this case, the radio base station can transmit parameters that relate to an SFN and/or a subframe index in each MIB (target MIB)-specific field, and not include these parameters in the shared information in the anchor MIB.

If the SFN and/or the subframe index of a target numerology are a predetermined time interval (for example, X) apart from the SFN and/or the subframe index of the anchor numerology, the parameter related to the SFN and/or the subframe index can be included in the shared information of the anchor MIB. The predetermined time interval may be a value that is determined in advance, or may be included in the anchor MIB and reported to the user terminal. By this means, the user terminal can receive the anchor MIB and learn the SFN and/or the subframe index of each numerology.

<Other Information>

Information that is specific to an anchor MIB is included in this anchor MIB and reported to the user terminal. Information that is unique to an anchor MIB might include parameters, related to the reference signals to use to receive an anchor numerology (for example, this anchor MIB) (for example, the port number, the time and/or frequency resource, and so on), parameters related to the PRACH (for example, a random access preamble index, the time and/or frequency resource, and so on), and so forth.

Information related to a target MIB is included in this target MIB and reported to the user terminal. Information related to a target MIB might include parameters related to the reference signals to use to receive a target numerology (for example, this target MIB) (for example, the port number, the time and/or frequency resource, and so on), parameters related to the PRACH (for example, a random access preamble index, the time and/or frequency resource, and so on), and so forth.

The time to detect a target MIB (the timing the user terminal detects a target MIB) may be configured at the time a predetermined time offset apart from the anchor MIB, or configured at the time a predetermined time offset apart from a synchronization signal (for example, a synchronization signal of the anchor numerology or a synchronization signal of the target numerology). Alternatively, the SFN and/or the subframe that is configured on a fixed basis for the target numerology may be used.

(User Terminal Operation)

After having received a synchronization signal (shared SS or separate SS), the user terminal detects an anchor MIB in an anchor numerology. As for the method of identifying the anchor numerology, the above-described methods can be used. Next, the user terminal selects target numerologies. If the user terminal supports only one numerology (anchor numerology), the user terminal receives the anchor MIB based on this anchor numerology, and performs subsequent procedures. (including receiving SIBs).

If the user terminal supports multiple numerologies, the user terminal receives MIBs that correspond to target numerologies that are selected based on the anchor MIB. After having received the target MIBs, the user terminal performs the process of receiving SIBs and/or other processes.

Thus, when MIBs of multiple numerologies are received based on an anchor MIB, shared information is included in the anchor MIB, which is certain to be received, so that it is not necessary to include this shared information in target MIBs. By this means, it is possible to reduce the increase in the overhead of target MIBs.

(Second Aspect)

In Accordance with a Second Aspect of the Present Invention, an Example case will be described below, where transmission and receipt of broadcast channels (MIBs) are controlled by configuring system information (contents of MIBs) separately on a per numerology basis. Furthermore, a case will be described below, with the second aspect, where a user terminal directly receives MIBs that correspond to respective numerologies.

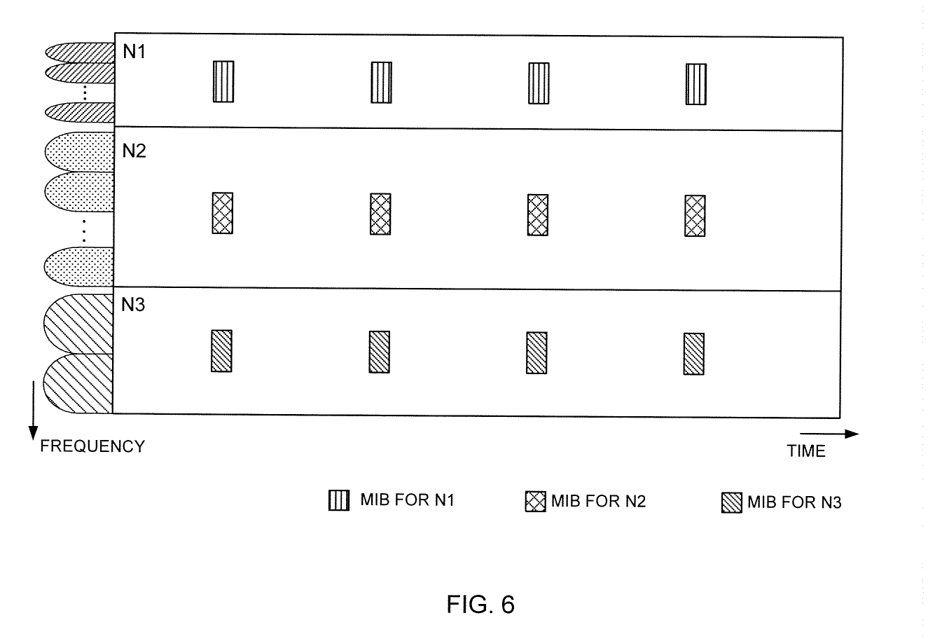

FIG. 6 illustrates a case where a user terminal directly (not via an anchor MIB) receives MIBs that are transmitted separately in respective numerologies (here, N1 to N3). Note that, although FIG. 6 shows a case where MIBs transmitted in respective numerologies are placed in the same time field (time resource), this is by no means limiting.

If the user terminal supports only one numerology, the user terminal performs the MIB receiving process (for example, blind detection) in accordance with the numerology the user terminal supports. By this means, the user terminal can selectively acquire system information that corresponds to the numerology the user terminal supports.

If the user terminal supports multiple numerologies, the user terminal can select a predetermined number, M (for example, M (≥1)), of numerologies as communicating numerologies (target numerologies). For example, the user terminal receives all the MIBs in the numerologies the user terminal supports, and, after receiving these, selects a predetermined number M of numerologies. The user terminal might determine the predetermined number M and M target numerologies, autonomously, based on the user terminal's capabilities and so on, or determine these based on commands from the radio base station. Alternatively, the user terminal may select target numerologies based on rules that are set forth in advance (or based on a selection table).

In the event the radio base station designates target numerologies for the user terminal, the radio base station reports, for example, information about the priorities of numerologies to the user terminal. This information about the priorities of numerologies can be included in MIBs corresponding to respective numerologies, and reported to the user terminal. Based on the information concerning the priorities of numerologies, the user terminal can select M target numerologies of higher priorities (including, for example, one with the highest priority), among the numerologies the user terminal supports.

Alternatively, the user terminal may select M numerologies before receiving MIBs. In this case, the user terminal can exert control so that only the MIBs that correspond to the selected target numerologies are received, in a selective manner. By this means, the receiving operation for MIBs other than the MIBs of target numerologies can be spared.

The user terminal receives the MIBs corresponding to the selected numerologies (target MIBs). For example, the user terminal controls receipt of target MIBs based on offsets that are configured in advance between a predetermined signal and the target MIBs. For this predetermined signal, a synchronization signal that is detected in the same numerology, and/or a synchronization signal that is detected in a different numerology can be used.

For example, if a common synchronization signal is configured in multiple numerologies (shared SS), the user terminal controls receipt of target MIBs based on offsets that are configured in advance between this shared synchronization signal and the target MIBs. Information about the offsets configured between the shared synchronization signal and the target MIBs may be defined in advance, or may be reported from the radio base station to the user terminal.

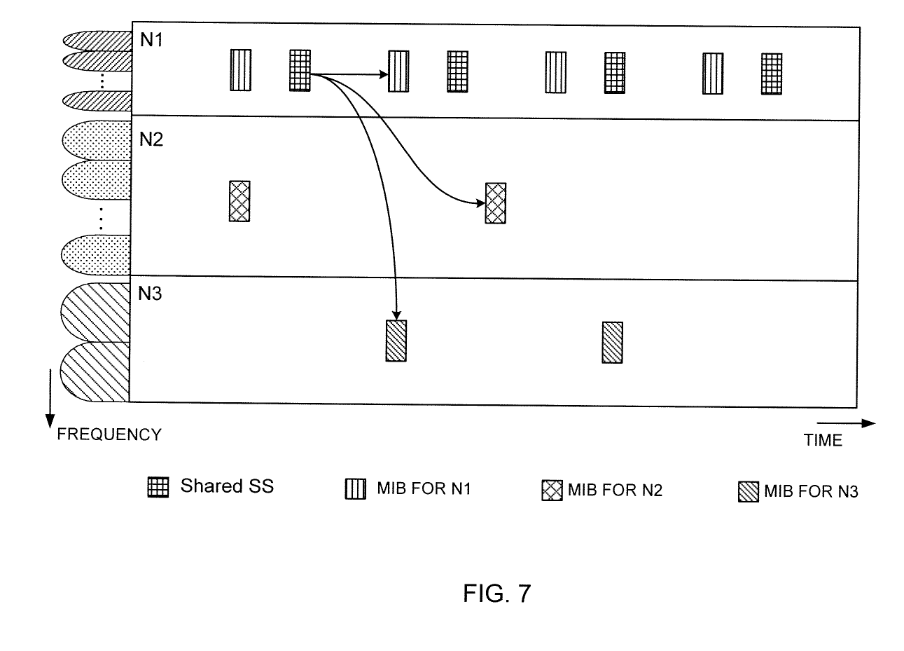

FIG. 7 illustrates an example case where a shared synchronization signal is transmitted in a predetermined numerology (here, N1), and where MIBs that are transmitted separately in respective numerologies (N1-N3) are received based on this shared synchronization signal. When the user terminal selects N1 to N3 as target numerologies, the user terminal controls receipt of the MIB of each numerology based on the shared synchronization signal (for example, based on the offset configured between the shared synchronization signal and the selected target numerologies). The offsets configured between the shared synchronization signal and each MIB may be determined in advance, or reported from the radio base station to the user terminal.

For example, the user terminal receives the MIB for N1 based on the offset (offset in frequency and/or time resources) configured between the shared synchronization signal and the MIB for N1 in the numerology in which the shared synchronized signal is transmitted (here N1). Similarly, based on the offset configured between the shared synchronization signal and the MIB for N2 and the offset configured between the shared synchronization signal and the MIB for N3, the user terminal receives the MIBs corresponding to respective numerologies. Note that information about the offsets between the MIBs for N2 and/or N3 and the shared synchronization signal may be included in the MIB for N1, and reported to the user terminal.

If separate synchronization signals are configured for each of multiple numerologies (separate SS), in each numerology, the user terminal can receive the MIB of that target numerology, based on the offset that is configured between the synchronization signal and the target numerology.

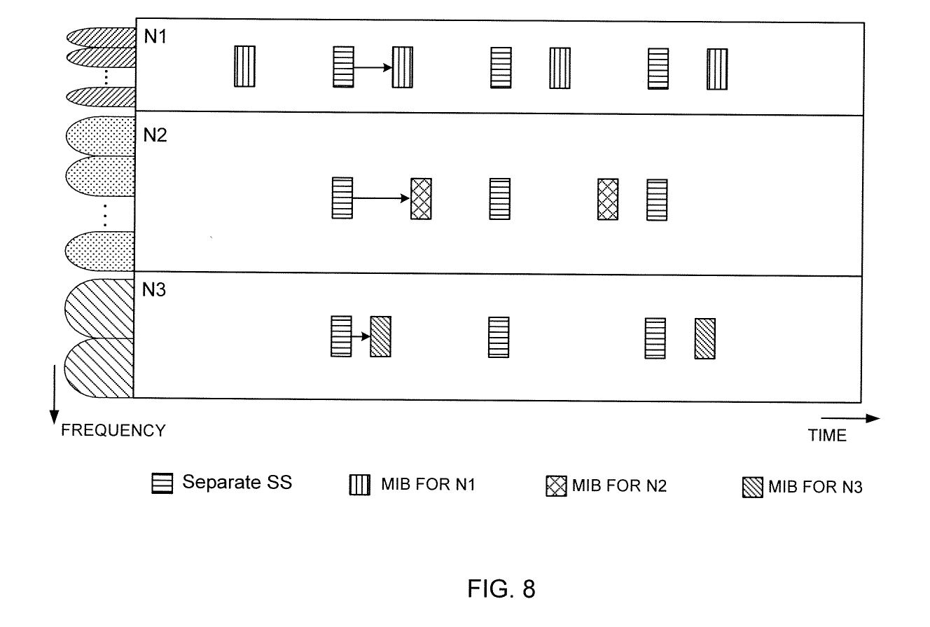

FIG. 8 illustrates a case where MIBs corresponding to respective numerologies are received based on synchronization signals that are transmitted separately in each numerology (here, N1 to N3). When the user terminal selects N1 to N3 as target numerologies, the user terminal receives the MIB of each numerology based on the synchronization signal of that numerology. In each numerology, an offset can be configured in advance between the synchronization signal and the MIB. Note that, the offset that is configured in each numerology between the synchronization signal and the MIB may be configured in common, or may be configured individually

Note that the offset (frequency and/or time resource offset) to be configured between a synchronization signal and an MIB can be configured in predetermined units (for example, in units of PRBs). The time to detect an MIB (the timing the user terminal detects an MIB) can be determined based on a fixed offset (time resource offset) that is configured based on the synchronization signal. Alternatively, the MIB may be configured in a predetermined system frame number and/or subframe index.

The MIB of each numerology can contain information that is specific to that numerology. In addition, system information (MIB) that is common to multiple numerologies may be included in the MIBs of respective numerologies. Note that the types of information that have been described earlier with the first aspect can be used here, as numerology-specific information and information that is common to multiple numerologies.

(User Terminal Operation)

After having received a synchronization signal (shared SS or separate SS), the user terminal selects target numerologies. If the user terminal supports only one numerology, the user terminal receives the MIB in this numerology and performs subsequent procedures (including receiving SIBs).

If the user terminal supports multiple numerologies, the user terminal receives MIBs in each of these numerologies, and then selects target numerologies. Alternatively, the user terminal selects target numerologies from multiple numerologies, and then receives MIBs in these target numerologies. After having received the target MIBs, the user terminal performs the SIB receiving process and/or other processes.

Thus, when receiving MIBs in a number of numerologies, the operation in the user terminal can be simplified by directly receiving MIBs corresponding to target numerologies (or supporting numerologies).

(Third Aspect)

In accordance with a third aspect of the present invention, an example case will be described below, where transmission and receipt of broadcast channels (MIBs) are controlled by combining system information (contents of MIBs) across a plurality of numerologies.

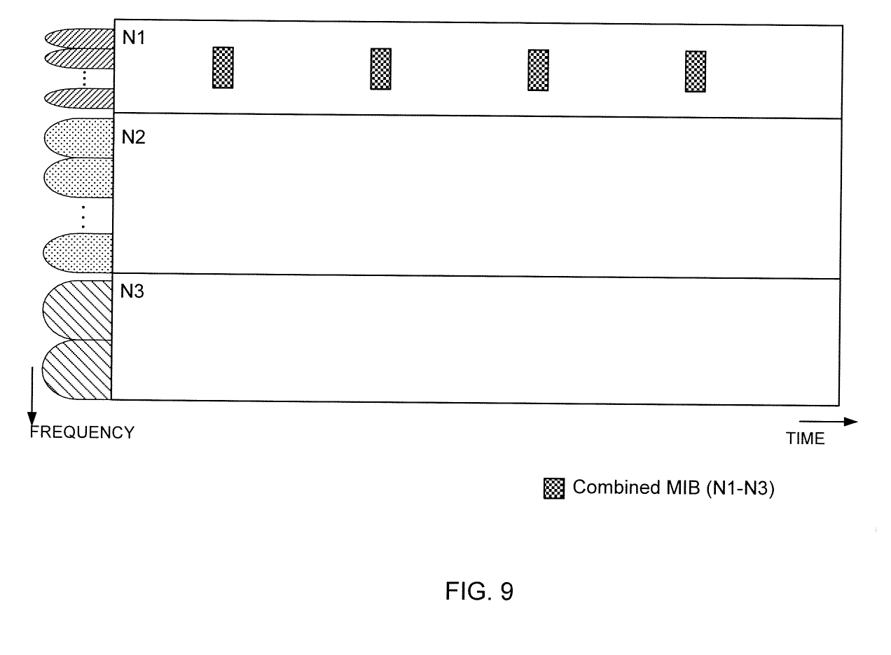

FIG. 9 illustrates a case where a user terminal receives an MIB (combined MIB) that is transmitted in a predetermined numerology (here, N1). The MIB transmitted in N1 contains system information that corresponds to numerologies N2 and N3, in addition to N1. That is, by receiving one MIB, the user terminal can acquire system information corresponding to a plurality of numerologies.

For example, the user terminal receives a synchronization signal transmitted from a radio base station, establishes synchronization, and then receives a combined MIB, which is transmitted in a predetermined numerology. As to the method by which the user terminal identifies in which numerology the combined MIB is transmitted, it is possible to use the method of determining this numerology in advance, use the method of identifying this numerology based on a predetermined signal (for example, a synchronization signal). The numerology in which the combined MIB is transmitted may be referred to as the “anchor numerology.

For example, if a common synchronization signal is configured in a number of numerologies (shared SS design), the user terminal determines that the numerology in which the shared synchronization signal is transmitted is the numerology the combined MIB is transmitted. In this case, the user terminal can learn in which numerology the combined MIB is transmitted by performing the receiving process (for example, blind detection) for the synchronization signal.

When separate synchronization signals are configured for each of multiple numerologies (separate SS design), a predetermined numerology may be designated in advance as being the numerology for transmitting a combined MIB. The predetermined numerology may be, for example, a numerology to use a certain subcarrier spacing (for example, 15 kHz).

The location (frequency and/or time resource) of this combined MIB transmitted in the predetermined numerology may be determined in advance. Alternatively, a structure may be adopted here, in which the combined MIB is placed in a location that is a predetermined offset (for example, a frequency and/or time resource offset) apart from the location of a synchronization signal (for example, the predetermined numerology's synchronization signal).

The user terminal selects at least one of the numerologies the user terminal supports, and controls communication accordingly. For example, if the user terminal supports only the predetermined numerology in which the combined MIB is transmitted, among a number of numerologies, the user terminal detects the combined MIB in this predetermined numerology and acquires system information.

If the user terminal supports multiple numerologies, the user terminal can select a predetermined number, M (for example, M (≥1)), of numerologies as target numerologies. The user terminal might determine the predetermined number M and M target numerologies, autonomously, based on the user terminal's capabilities and so on, or determine these based on commands from the radio base station. Alternatively, the user terminal may select numerologies based on rules that are set forth in advance (or based on a selection table).

In the event the radio base station designates target numerologies for the user terminal, the radio base station reports, for example, information about the priorities of numerologies to the user terminal. This information about the priorities of numerologies can be included in the anchor MIB and/or in SIBs transmitted in the anchor numerology, and so on, and reported to the user terminal. Based on the information concerning the priorities of numerologies, the user terminal can select M target numerologies (including, for example, one with the highest priority), among the numerologies the user terminal supports.

The user terminal acquires the system information corresponding to the selected target numerologies from the combined MIB. The combined MIB can contain information that is common in multiple numerologies, information that is unique to each numerology, and so on. For example, the radio base station can include information that designates target numerologies in the combined MIB, and reports this combined MIB to the user terminal. For example, the radio base station reports information that designates target numerologies, to the user terminal, by using predetermined bits (for example, two bits).

These two bits are configured so that, for example, a numerology with a subcarrier spacing of 15 KHz (for example, N1) and a numerology of 30 KHz (N2) are “00,” a numerology with a subcarrier spacing of 15 KHz (for example, N1) and a numerology of 60 KHz (N3) are “01,” and a numerology with a subcarrier spacing of 15 KHz (for example, N1), a numerology of 30 KHz (for example, N2) and a numerology of 60 KHz (N3) are “10” (and “11” is reserved). The user terminal can identify target numerologies based on what bit value is provided in a combined MIB.

Alternatively, information that designates target numerologies may be reported to the user terminal in the form of bitmap (for example, a three-bit bitmap corresponding to N1 to N3).

Also, when a common SFN and/or subframe index is used between different numerologies, information about this SFN and/or subframe index is included in a combined MIB and reported to the user terminal. Alternatively, when an SFN and/or a subframe index that is unique to a certain numerology is used, information about this numerology-specific SFN and/or subframe index is included in a combined MIB and reported to the user terminal.

Also, information about the configuration of each numerology may be included in a combined MIB. Information about the center field of a target numerology (the index of the center PRB) may be included in a combined MIB and reported to the user terminal. Information about the center field (the index of the center PRB) of a target numerology may be, for example, the offset that is configured between a given numerology (the numerology in which a combined MIB is transmitted) and the target numerology. The user terminal can perform subsequent processes (for example random access procedures) properly based on information about the target numerology's configuration.

Also, parameters (for example, the port number, the time and/or frequency resource, and so on) related to the reference signals to use to receive the target numerology, parameters related to the PRACH (for example, a random access preamble index, the time and/or frequency resource, etc.) and so forth may be included in a combined MIB.

(User Terminal Operation)

After having received a synchronization signal (shared SS or separate SS), the user terminal detects a combined MIB in a predetermined numerology. As to the method of identifying the numerology in which the combined MIB is transmitted, the methods described earlier can be used. Next, the user terminal selects target numerologies. The target numerology may be selected based on information contained in the combined MIB. If the user terminal supports only one numerology, the user terminal receives the combined MIB in this numerology, and performs subsequent procedures (including receiving SIBs).

When the user terminal supports multiple numerologies, the user terminal selects target numerologies, and acquires system information that corresponds to the target numerologies, from the combined MIB. Having acquired the system information corresponding to the target numerologies, the user terminal performs SIB receiving process and/or other processes.

In this way, by configuring a combined MIB that bundles MIBs of a number of numerologies, system information that corresponds to separate numerologies can be acquired by receiving one MIB. By this means, it is possible to avoid performing the receiving process for multiple MIBs.

(Variation 1)

Although an example has been shown above with reference to FIG. 9 where system information (MIBs) to correspond to a number of numerologies (all of N1 to N3) are combined and transmitted as a combined MIB, system information to correspond to part of these numerologies may be selectively combined and form a combined MIB.

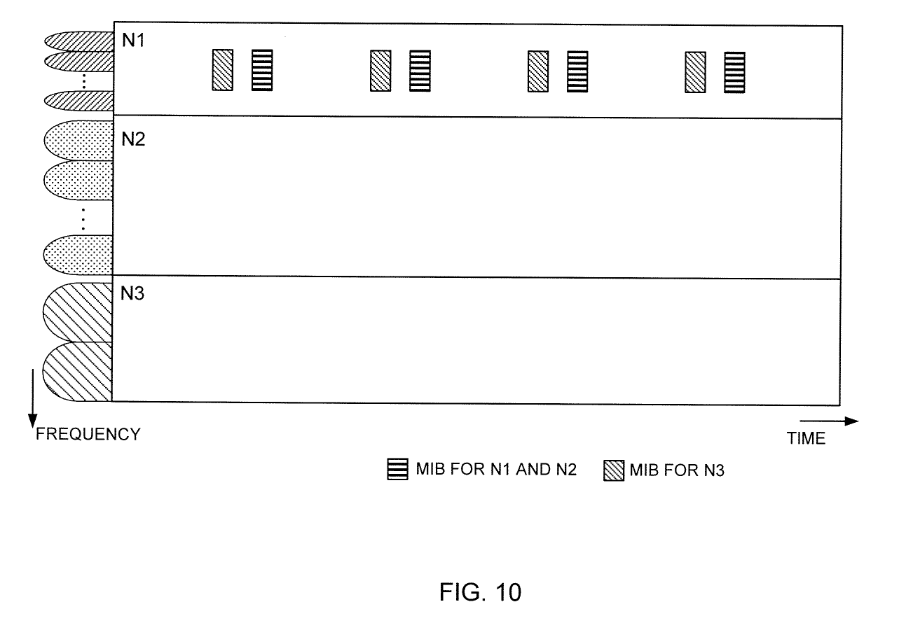

FIG. 10 shows a case where system information corresponding to two numerologies (for example, N1 and N2), out of three numerologies (N1 to N3), is selected and form a combined MIB, and transmitted. In this case, the system information of the remaining one numerology (N3) is transmitted apart from the combined MIB. The combined MIB, which bundles MIBs of two numerologies, may be referred to as a “hybrid MIB.”

The combined MIB bundling pieces of system information corresponding to N1 and N2 and the MIB containing the system information of N3 may be transmitted by using the same numerology, or transmitted using different numerologies. A numerology (here, N1), in which an MIB corresponding to another numerology is transmitted, may be referred to as an “anchor numerology.” As to the method by which the user terminal identifies this anchor numerology, the method described in the first aspect or the third aspect can be used.

Which numerologies' system information is combined can be selected as appropriate. For example, MIBs of numerologies where the cycle of transmitting the broadcast channel (PBCH) is the same can be combined with each other and form a combined MIB. Alternatively, MIBs of numerologies that are configured alike (for example, the subcarrier spacing is close) may be combined with each other and form a combined MIB. For example, when three numerologies with subcarrier spacings of 15 KHz, 30 KHz and 60 KHz are configured, it is preferable to combine the numerology of 15 KHz and the numerology of 30 KHz.

The location (frequency and/or time resource) to place the combined MIB and/or the MIB of the other numerology can be a location that is a predetermined offset (frequency and/or time resource offset) apart from a predetermined signal (for example, a synchronization signal).

In a combined MIB that bundles pieces of system information corresponding to a number of numerologies (for example, N1 and N2), the system information corresponding to N1 and N2 is included and reported to the user terminal. In the MIB transmitted apart from the combined MIB, the system information corresponding to N3 is included and reported to the user terminal. The system information corresponding to N3 may include information about the configuration of N3 (for example, the center frequency (center PRB) at N3), information about the SFN and/or the subframe index used in N3, information about the reference signals used in N3, information about the PRACH used in N3, and so on.

(User Terminal Operation)

First, the user terminal receives a synchronization signal (shared SS or separate SS). After that, the user terminal detects MIBs corresponding to a number of numerologies the user terminal supports, and then selects target numerologies. Alternatively, the user terminal may select target numerologies, and then detect the MIBs corresponding to the selected target numerologies, in a selective manner.

In this way, instead of combining the system information of all numerologies, the system information corresponding to part of the numerologies is transmitted apart from the combined MIB, so that it is possible to flexibly control transmission and receipt of system information that corresponds to respective numerologies.

(Variation 2)

Although a case has been shown above with reference to FIG. 2 where an anchor MIB and other MIBs (target MIBs) received based on this anchor MIB are configured in different numerologies (frequency bands), the target MIBs may be transmitted in the anchor numerology.

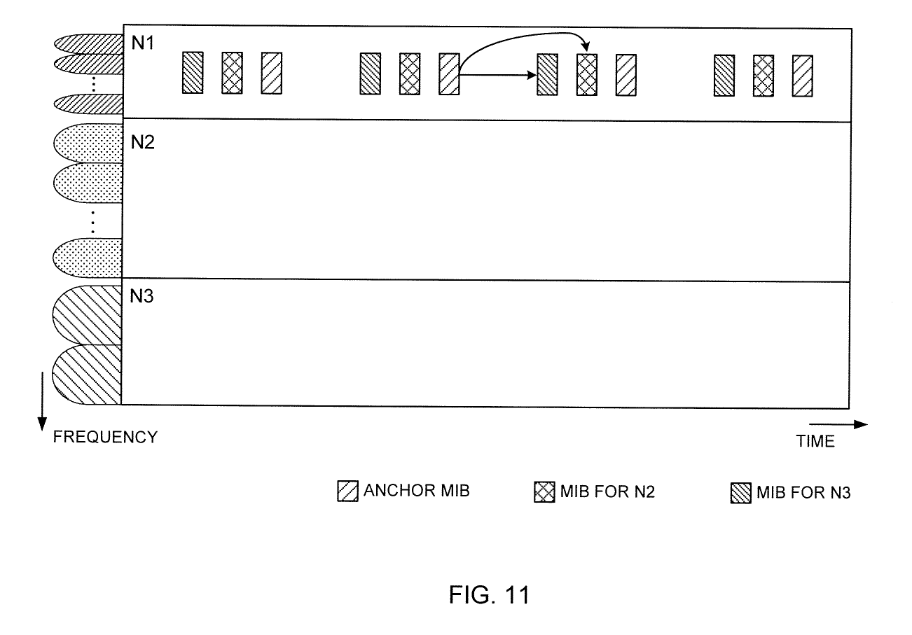

FIG. 11 shows a case where an anchor MIB and target MIBs that are received based on this anchor MIB are transmitted in the anchor numerology (here, N1). The method of identifying the anchor numerology in which the anchor MIB is transmitted and the location where the anchor MIB is placed can be configured as in the first aspect described above.

The location (for example, the time resource) where a target MIB is placed may be configured based on the offset that is configured between the anchor MIB and the target MIB, or configured based on a fixed SFN and/or subframe index that are determined in advance. When an offset is configured between an anchor MIB and each target MIB, information about this offset may be included in the anchor MIB and reported to the user terminal.

The system information to include in the anchor MIB and/or the system information to include in the target MIB can be configured as in the first aspect described above.

(User Terminal Operation)

After having received a synchronization signal (shared SS or separate SS), the user terminal detects an anchor MIB in an anchor numerology. As to the method of identifying the anchor numerology, the method described with the first aspect can be used. Next, the user terminal selects target numerologies.

If the user terminal supports multiple numerologies, the user terminal receives MIBs corresponding to the target numerologies selected based on the anchor MIB. After having received the target MIBs, the user terminal performs the SIB receiving process and/or other processes.

Thus, the target MIBs and the anchor MIB are all transmitted in the same anchor numerology, so that the user terminal can receive system information corresponding to separate numerologies in the same numerology. Also, by configuring an anchor MIB and a target MIB in the same frequency location, the user terminal can receive the target MIB by considering only the time offset from a predetermined signal (for example, the anchor MIB). In this case, information about the frequency offset is no longer required, so that the increase in overhead can be reduced.

(Radio Communication System)

Now, the structure of a radio communication system according to the present embodiment will be described below. In this radio communication system, the radio communication methods according to the above-described embodiments are employed. Note that the radio communication method according to each embodiment described above may be used alone or may be used in combination.

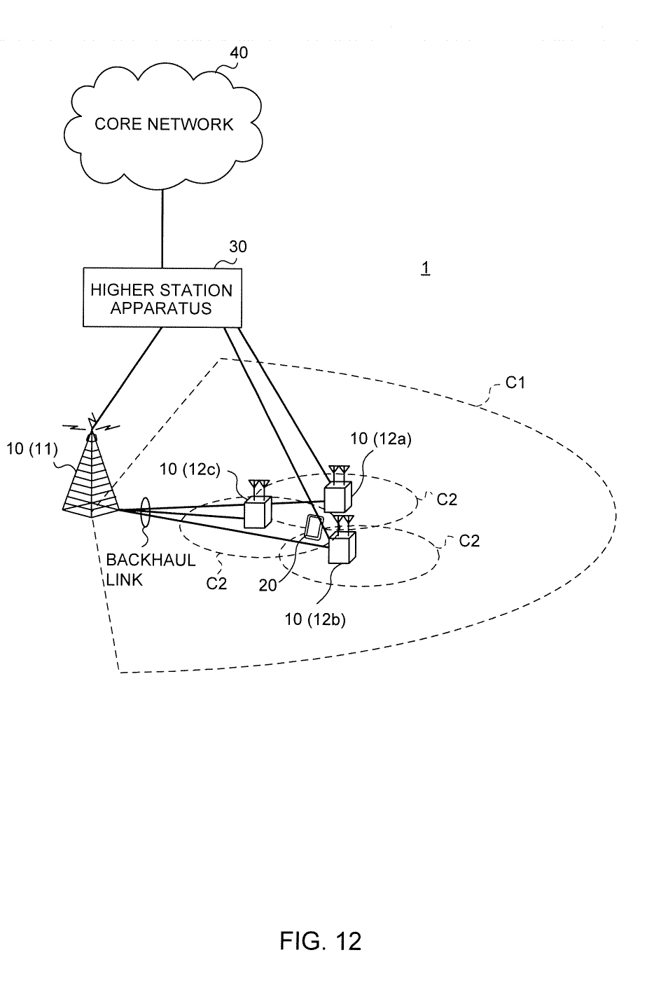

FIG. 12 is a diagram to show an example of a schematic structure of a radio communication system according to the present embodiment. A radio communication system 1 can adopt carrier aggregation (CA) and/or dual connectivity (DC) to group a plurality of fundamental frequency blocks (component carriers) into one, where the LTE system bandwidth (for example, 20 MHz) constitutes one unit. Note that the radio communication system 1 may be referred to as “SUPER 3G,” “LTE-A (LTE-Advanced),” IMT-Advanced,” “4G,” “5G,” “FRA (Future Radio Access),” “NR (New Rat)” and so on.

The radio communication system 1 shown in FIG. 12 includes a radio base station 11 that forms a macro cell C1, and radio base stations 12a to 12c that are placed within the macro cell C1 and that form small cells C2, which are narrower than the macro cell C1. Also, user terminals 20 are placed in the macro cell C1 and in each small cell C2. A configuration may be employed here in which different numerologies are applied between cells. Note that a “numerology” refers to a set of communication parameters that characterize the design of signals in a given RAT and the design of the RAT.

The user terminals 20 can connect with both the radio base station 11 and the radio base stations 12. The user terminals 20 may use the macro cell C1 and the small cells C2, which use different frequencies, at the same time, by means of CA or DC. Also, the user terminals 20 can execute CA or DC by using a plurality of cells (CCs) (for example, two or more CCs). Furthermore, the user terminals can use licensed-band CCs and unlicensed-band CCs as a plurality of cells. Note that it is possible to adopt a configuration in which a TDD carrier to use shortened TTIs is included in one of these multiple cells.

Between the user terminals 20 and the radio base station 11, communication is carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz, 30 to 70 GHz and so on) and a wide bandwidth may be used, or the same carrier as that used in the radio base station 11 may be used. Note that the structure of the frequency band for use in each radio base station is by no means limited to these.

A structure may be employed here, in which wire connection (for example, optical fiber in compliance with the CPRI (Common Public Radio Interface), the X2 interface and so on) or wireless connection is established between the radio base station 11 and the radio base station 12 (or between two radio base stations 12).

The radio base station 11 and the radio base stations 12 are each connected with higher station apparatus 30, and are connected with a core network 40 via the higher station apparatus 30. Note that the higher station apparatus 30 may be, for example, access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB (eNodeB),” a “transmitting/receiving point” and so on. Also, the radio base stations 12 are radio base stations having local coverages, and may be referred to as “small base stations,” “micro base stations,” “pico base stations,” “femto base stations,” “HeNBs (home eNodeBs),” “RRHs (Remote Radio Heads),” “transmitting/receiving points” and so on. Hereinafter the radio base stations 11 and 12 will be collectively referred to as “radio base stations 10,” unless specified otherwise.

The user terminals 20 are terminals to support various communication schemes such as LTE, LTE-A and so on, and may be either mobile communication terminals or stationary communication terminals.

In the radio communication system 1, as radio access schemes, OFDMA (orthogonal Frequency Division Multiple Access) can be applied to the downlink (DL), and SC-FDMA (Single-Carrier Frequency Division Multiple Access) can be applied to the uplink (UL). OFDMA is a multi-carrier communication scheme to perform communication by dividing a frequency bandwidth into a plurality of narrow frequency bandwidths (subcarriers) and mapping data to each subcarrier. SC-FDMA is a single-carrier communication scheme to mitigate interference between terminals by dividing the system bandwidth into bands formed with one or continuous resource blocks per terminal, and allowing a plurality of terminals to use mutually different bands. Note that the uplink and downlink radio access schemes are not limited to the combination of these, and OFDMA may be used in the UL.

In the radio communication system 1, a DL data channel (PDSCH (Physical Downlink Shared CHannel), which is also referred to as a “DL shared channel” and so on), which is shared by each user terminal 20, a broadcast channel (PBCH (Physical Broadcast CHannel)), L1/L2 control channels and so on are used as DL channels. User data, higher layer control information and SIBs (System Information Blocks) are communicated in the PDSCH. Also, the MIB (Master Information Block) is communicated in the PBCH.

The L1/L2 control channels include DL control channels (PDCCH (Physical Downlink Control CHannel), EPDCCH (Enhanced Physical Downlink Control CHannel) and so on), a PCFICH (Physical Control Format Indicator CHannel), a PHICH (Physical Hybrid-ARQ Indicator CHannel) and so on. Downlink control information (DCI), including PDSCH and PUSCH scheduling information, is communicated by the PDCCH. The number of OFDM symbols to use for the PDCCH is communicated by the PCFICH. HARQ delivery acknowledgement information (ACK/NACK) in response to the PUSCH is communicated by the PHICH. The EPDCCH is frequency-division-multiplexed with the PDSCH (downlink shared data channel) and used to communicate DCI and so on, like the PDCCH.

In the radio communication system 1, a UL data channel (PUSCH (Physical Uplink Shared CHannel), which is also referred to as a “UL shared channel” and so on), which is shared by each user terminal 20, a UL control channel (PUCCH (Physical Uplink Control CHannel)), a random access channel (PRACH (Physical Random Access CHannel)) and so on are used as UL channels. User data, higher layer control information and so on are communicated by the PUSCH. Uplink control information (UCI), including at least one of delivery acknowledgment information (ACK/NACK) and radio quality information (CQI), is communicated via the PUSCH or the PUCCH. By means of the PRACH, random access preambles for establishing connections with cells are communicated.

(Radio Base Station)

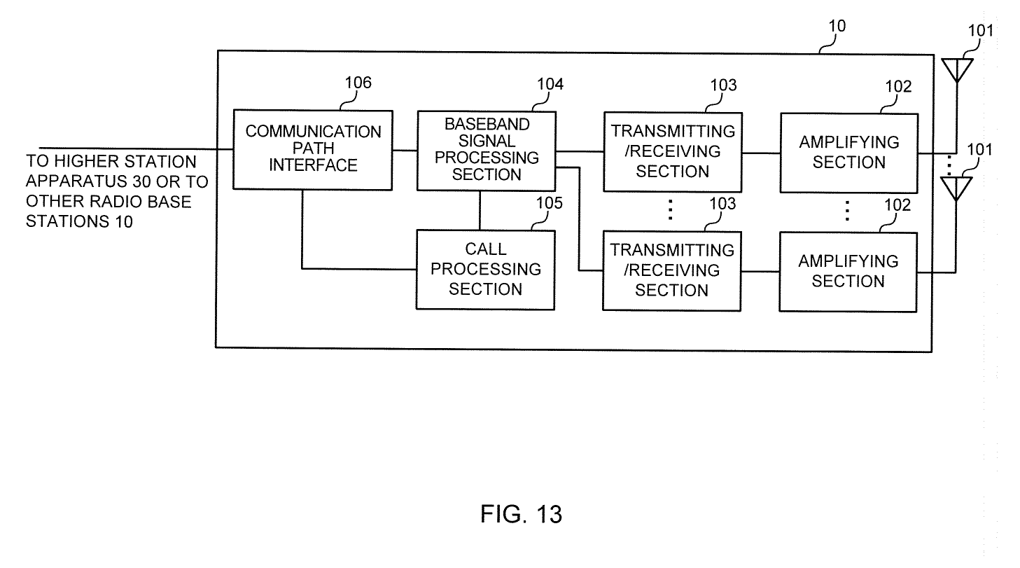

FIG. 13 is a diagram to show an example of an overall structure of a radio base station according to the present embodiment. A radio base station 10 has a plurality of transmitting/receiving antennas 101, amplifying sections 102, transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided.

DL data to be transmitted from the radio base station 10 to a user terminal 20 is input from the higher station apparatus 30 to the baseband signal processing section 104, via the communication path interface 106.

In the baseband signal processing section 104, the DL data is subjected to transmission process, including a PDCP (Packet Data Convergence Protocol) layer process, division and coupling of user data, RLC (Radio Link Control) layer transmission processes such as RLC retransmission control, MAC (Medium Access Control) retransmission control (for example, HARQ (Hybrid Automatic Repeat reQuest) transmission process), scheduling, transport format selection, to channel coding, an inverse fast Fourier transform (IFFT) process and a precoding process, and the result is forwarded to the transmitting/receiving sections 103. Furthermore, DL control signals are also subjected to transmission process such as channel coding and an inverse fast Fourier transform, and forwarded to the transmitting/receiving sections 103.

Baseband signals that are precoded and output from the baseband signal processing section 104 on a per antenna basis are converted into a radio frequency band in the transmitting/receiving sections 103, and then transmitted. The radio frequency signals having been subjected to frequency conversion in the transmitting/receiving sections 103 are amplified in the amplifying sections 102, and transmitted from the transmitting/receiving antennas 101. The transmitting/receiving sections 103 can be constituted by transmitters/receivers, transmitting/receiving circuits or transmitting/receiving apparatus that can be described based on general understanding of the technical field to which the present invention pertains. Note that a transmitting/receiving section 103 may be structured as a transmitting/receiving section in one entity, or may be constituted by a transmitting section and a receiving section.

Meanwhile, as for UL signals, radio frequency signals that are received in the transmitting/receiving antennas 101 are amplified in the amplifying sections 102. The transmitting/receiving sections 103 receive the UL signals amplified in the amplifying sections 102. The received signals are converted into the baseband signal through frequency conversion in the transmitting/receiving sections 103 and output to the baseband signal processing section 104.

In the baseband signal processing section 104, user data that is included in the UL signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base stations 10 and manages the radio resources.

The communication path interface section 106 transmits and receives signals to and from the higher station apparatus 30 via a predetermined interface. Also, the communication path interface 106 may transmit and receive signals (backhaul signaling) with other radio base stations 10 via an inter-base station interface (which is, for example, optical fiber that is in compliance with the CPRI (Common Public Radio Interface), the X2 interface, etc.).

Note that the transmitting/receiving sections 103 transmit DL signals (for example, a DL control signal (DL control channel), a DL data signal (DL data channel, DL shared channel and so on), a DL reference signal (DM-RS, CSI-RS and so on), a discovery signal, a synchronization signal, a broadcast signal and so on), and receive UL signals (for example, a UL control signal (UL control channel), a UL data signal (UL data channel, UL shared channel and so on), a UL reference signal and so on).

To be more specific, the transmitting/receiving sections 103 transmit system information (MIB) of separate numerologies to user terminals. For example, the transmitting/receiving sections 103 transmit an anchor MIB (anchor broadcast channel) in an anchor numerology and a target MIB (target broadcast channel) in the anchor numerology and/or in a target numerology (see FIG. 2 and FIG. 11). The anchor MIB contains information about a bandwidth in which multiple numerologies are configured, information about the field in which the target MIB is placed, information about the SFN and/or the subframe index, information about the structure of reference signals, the structure of the PRACH, and so on. The target MIB contains target numerology-specific information.

Furthermore, in each numerology, the transmitting/receiving sections 103 transmit an MIB corresponding to that numerology (see FIG. 6). Alternatively, the transmitting/receiving sections 103 transmit, in a predetermined numerology, a combined MIB, in which part or all of multiple numerologies are combined (see FIG. 9 and FIG. 10).

The transmitting/receiving sections of the present invention are constituted by a transmitting/receiving section 103 and/or a communication path interface 106.

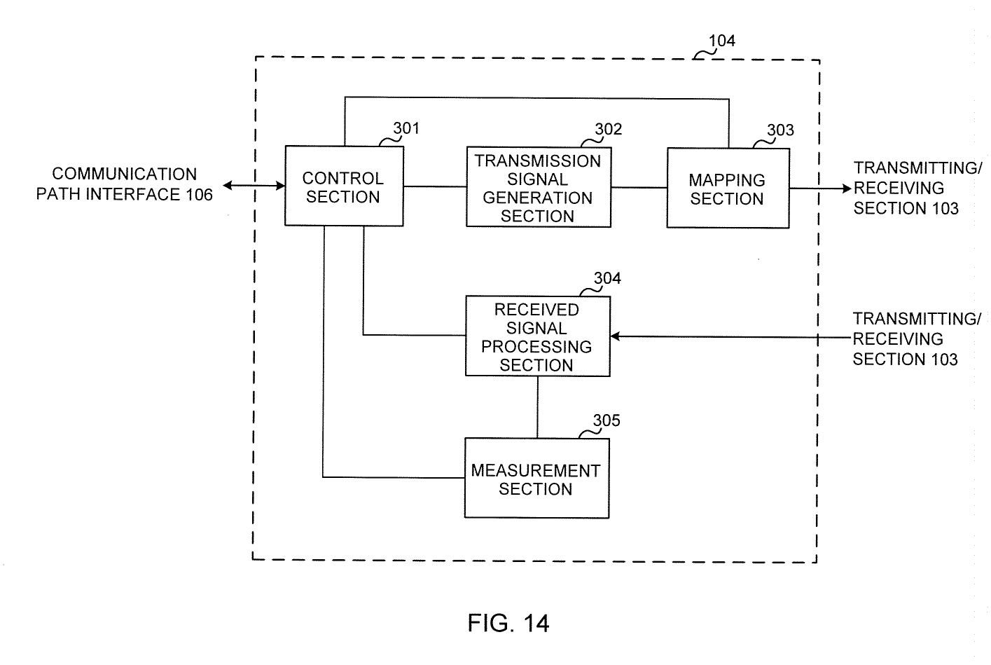

FIG. 14 is a diagram to show an example of a functional structure of a radio base station according to the present embodiment. Note that, although FIG. 14 primarily shows functional blocks that pertain to characteristic parts of the present embodiment, the radio base station 10 also has other functional blocks that are necessary for radio communication. As shown in FIG. 14, the baseband signal processing section 104 at least has a control section 301, a transmission signal generation section 302, a mapping section 303, a received signal processing section 304 and a measurement section 305.

The control section 301 controls the whole of the radio base station 10. The control section 301 can be constituted by a controller, a control circuit or control apparatus that can be described based on general understanding of the technical field to which the present invention pertains.

The control section 301, for example, controls generation of signals (system information, MIBs and so on) in the transmission signal generation section 302, allocation of signals in the mapping section 303, and so on. Furthermore, the control section 301 controls the signal receiving process in the received signal processing section 304, measurements of signals in the measurement section 305, and so on.

The control section 301 controls the scheduling (for example, resource allocation) of DL signals and/or UL signals. To be more specific, the control section 301 controls the transmission signal generation section 302, the mapping section 303 and the transmitting/receiving sections 103 to generate and transmit system information (MIB, SIB and so on), DCI (DL assignment), which includes DL data channel-scheduling information, DL reference signals, DCI (UL grant), which includes UL data channel-scheduling information, UL reference signals, and so on.

The control section 301 can control allocation so that MIBs (anchor MIB, target MIB, etc.) corresponding to varying numerologies are frequency-division-multiplexed and/or time-division-multiplexed.

The transmission signal generation section 302 generates DL signals (DL control channel, DL data channel, DL reference signals and so on) as commanded by the control section 301, and outputs these DL signals to the mapping section 303. The transmission signal generation section 302 can be constituted by a signal generator, a signal generating circuit or signal generating apparatus that can be described based on general understanding of the technical field to which the present invention pertains.

The mapping section 303 maps the DL signals generated in the transmission signal generation section 302 to predetermined radio resources, as commanded by the control section 301, and outputs these to the transmitting/receiving sections 103. The mapping section 303 can be constituted by a mapper, a mapping circuit or mapping apparatus that can be described based on general understanding of the technical field to which the present invention pertains.

The received signal processing section 304 performs the receiving process (for example, demapping, demodulation, decoding and so on) for the received signals that are input from the transmitting/receiving sections 103. Here, the received signals are, for example, UL signals that are transmitted from the user terminals 20 (UL control channel, UL data channel, UL reference signals, and so on). For the received signal processing section 304, a signal processor, a signal processing circuit or signal processing apparatus that can be described based on general understanding of the technical field to which the present invention pertains can be used.

The received signal processing section 304 outputs the decoded information, acquired through the receiving process, to the control section 301. For example, the received signal processing section 304 outputs at least one of a preamble, control information and UL data, to the control section 301. Also, the received signal processing section 304 outputs the received signals, the signals after the receiving process and so on, to the measurement section 305.

The measurement section 305 conducts measurements with respect to the received signal. The measurement section 305 can be constituted by a measurer, a measurement circuit or measurement apparatus that can be described based on general understanding of the technical field to which the present invention pertains.

The measurement section 305 may measure, for example, the received signals' received power (for example, RSRP (Reference Signal Received Power)), received quality (for example, RSRQ (Reference Signal Received Quality)), channel states and so on. The measurement results may be output to the control section 301.

(User Terminal)

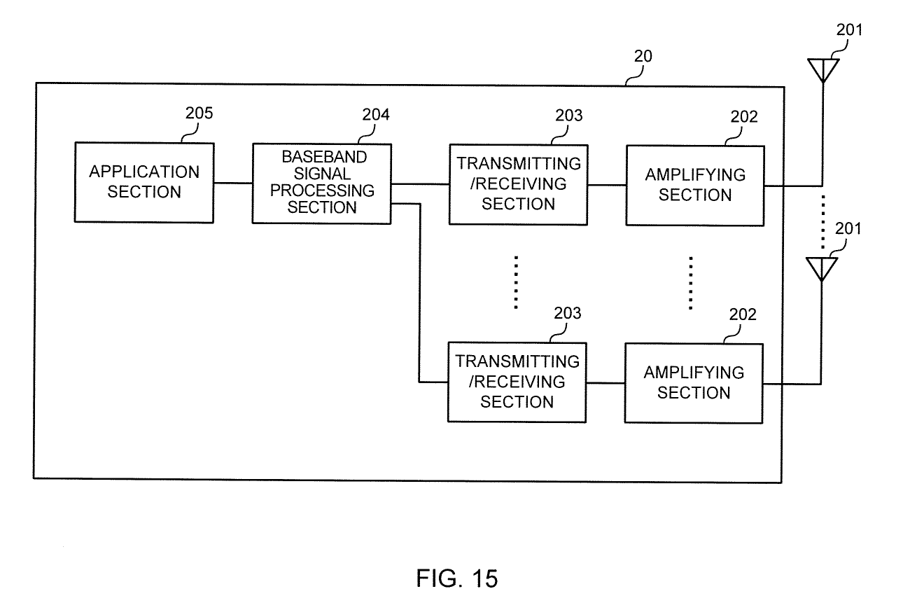

FIG. 15 is a diagram to show an example of an overall structure of a user terminal according to the present embodiment. A user terminal 20 has a plurality of transmitting/receiving antennas 201, amplifying sections 202, transmitting/receiving sections 203, a baseband signal processing section 204 and an application section 205. Note that one or more transmitting/receiving antennas 201, amplifying sections 202 and transmitting/receiving sections 203 may be provided.

Radio frequency signals that are received in the transmitting/receiving antennas 201 are amplified in the amplifying sections 202. The transmitting/receiving sections 203 receive the DL signals amplified in the amplifying sections 202. The received signals are subjected to frequency conversion and converted into the baseband signal in the transmitting/receiving sections 203, and output to the baseband signal processing section 204. A transmitting/receiving section 203 can be constituted by a transmitters/receiver, a transmitting/receiving circuit or transmitting/receiving apparatus that can be described based on general understanding of the technical field to which the present invention pertains. Note that a transmitting/receiving section 203 may be structured as a transmitting/receiving section in one entity, or may be constituted by a transmitting section and a receiving section.

In the baseband signal processing section 204, the baseband signal that is input is subjected to an FFT process, error correction decoding, a retransmission control receiving process and so on. The DL data is forwarded to the application section 205. The application section 205 performs processes related to higher layers above the physical layer and the MAC layer, and/or other processes. Also, in the DL data, system information and higher layer control information are also forwarded to the application section 205.

Meanwhile, UL data is input from the application section 205 to the baseband signal processing section 204. The baseband signal processing section 204 performs retransmission control transmission process (for example, an HARQ transmission process), channel coding, pre-coding, a discrete Fourier transform (DFT) process, an IFFT process and so on, and the result is forwarded to the transmitting/receiving sections 203. Baseband signals that are output from the baseband signal processing section 204 are converted into a radio frequency band in the transmitting/receiving sections 203 and transmitted. The radio frequency signals that are subjected to frequency conversion in the transmitting/receiving sections 203 are amplified in the amplifying sections 202, and transmitted from the transmitting/receiving antennas 201.

Note that the transmitting/receiving sections 203 receive DL signals (for example, a DL control signal (DL control channel), a DL data signal (DL data channel, DL shared channel and so on), a DL reference signal (DM-RS, CSI-RS and so on), a discovery signal, a synchronization signal, a broadcast signal and so on), and transmit UL signals (for example, a UL control signal (UL control channel), a UL data signal (UL data channel, UL shared channel and so on), a UL reference signal and so on).

To be more specific, the transmitting/receiving sections 203 receive system information (MIB) corresponding to separate numerologies from the radio base station. For example, the transmitting/receiving sections 203 receive an anchor MIB (anchor broadcast channel) in an anchor numerology and a target MIB (target broadcast channel) in the anchor numerology and/or a target numerology (see FIG. 2 and FIG. 11). The anchor MIB contains information about a bandwidth in which multiple numerologies are configured, information about the field in which the target MIB is placed, information about the SFN and/or the subframe index, information about the structure of reference signals, the structure of the PRACH, and so on. The target MIB contains target numerology-specific information.

In addition, in each numerology, the transmitting/receiving sections 203 receive the MIB corresponding to that numerology (see FIG. 6). Alternatively, the transmitting/receiving sections 203 receive, in a predetermined numerology, a combined MIB, in which part or all of multiple numerologies are combined (see FIG. 9 and FIG. 10).

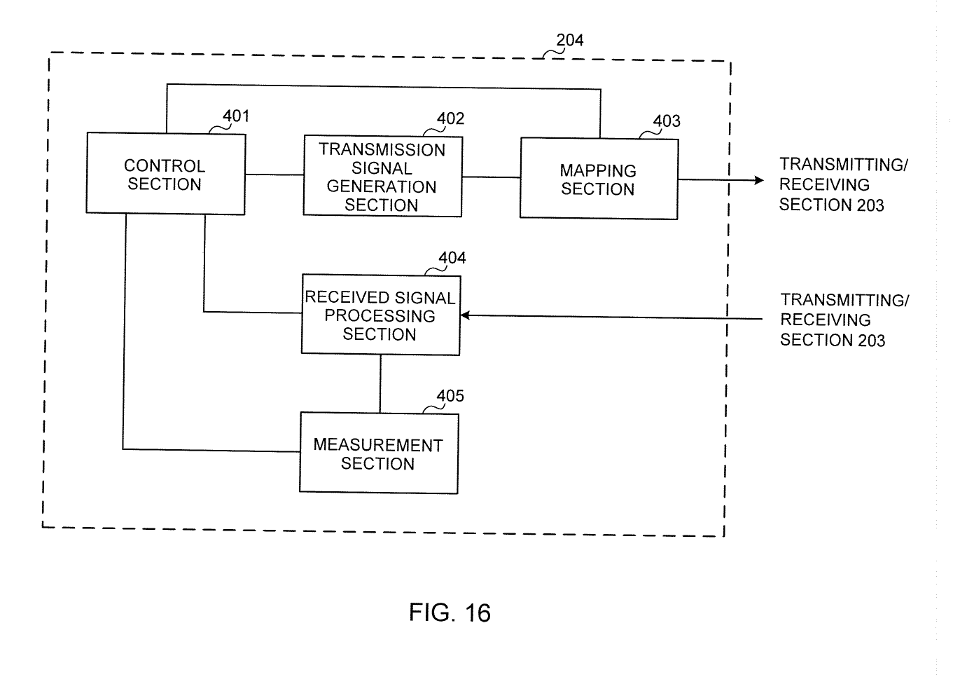

FIG. 16 is a diagram to show an example of a functional structure of a user terminal according to the present embodiment. Note that, although FIG. 16 primarily shows functional blocks that pertain to characteristic parts of the present embodiment, the user terminal 20 also has other functional blocks that are necessary for radio communication. As shown in FIG. 16, the baseband signal processing section 204 provided in the user terminal 20 at least has a control section 401, a transmission signal generation section 402, a mapping section 403, a received signal processing section 404 and a measurement section 405.

The control section 401 controls the whole of the user terminal 20. For the control section 401, a controller, a control circuit or control apparatus that can be described based on general understanding of the technical field to which the present invention pertains can be used.

The control section 401 controls, for example, generation of signals in the transmission signal generation section 402, allocation of signals in the mapping section 403, and so on. Furthermore, the control section 401 controls signal receiving process in the received signal processing section 404, measurements of signals in the measurement section 405, and so on.

The control section 401 controls receipt of broadcast channels (MIBs) that are transmitted in respective numerologies, or broadcast channels (MIBs) that are transmitted in a predetermined numerology in a selective manner. For example, based on an anchor broadcast channel, which is transmitted in a predetermined numerology, the control section 401 controls receipt of broadcast channels that are transmitted in other numerologies (see FIG. 2). In addition, the control section 401 exerts control so that the broadcast channel, transmitted separately in each numerology, is received based on the offset that is configured between a predetermined signal and the broadcast channel (see FIG. 7 and FIG. 8).

Alternatively, the control section 401 exerts control so that information (combined MIB), in which pieces of system information corresponding to a number of numerologies are combined, is received in a predetermined numerology (see FIG. 9 and FIG. 10). Alternatively, the control section 401 exerts control so that an anchor broadcast channel is received in a predetermined numerology, and, furthermore, based on this anchor broadcast channel, a broadcast channel, which contains system information corresponding to other numerologies, is received in this predetermined numerology (see FIG. 11).

The transmission signal generation section 402 generates UL signals (UL control channel, UL data channel, UL reference signals and so on) as commanded by the control section 401, and outputs the UL signals to the mapping section 403. The transmission signal generation section 402 can be constituted by a signal generator, a signal generating circuit or signal generating apparatus that can be described based on general understanding of the technical field to which the present invention pertains.

Also, the transmission signal generation section 402 generates UL data channels as commanded by the control section 401. For example, when a UL grant is included in a DL control channel that is reported from the radio base station 10, the control section 401 commands the transmission signal generation section 402 to generate a UL data channel.

The mapping section 403 maps the UL signals generated in the transmission signal generation section 402 to radio resources as commanded from the control section 401, and output the result to the transmitting/receiving sections 203. The mapping section 403 can be constituted by a mapper, a mapping circuit or mapping apparatus that can be described based on general understanding of the technical field to which the present invention pertains.

The received signal processing section 404 performs the receiving process (for example, demapping, demodulation, decoding and so on) of received signals that are input from the transmitting/receiving sections 203. Here, the received signals include, for example, DL signals transmitted from the radio base station 10 (DL control channel, DL data channel, DL reference signals and so on). The received signal processing section 404 can be constituted by a signal processor, a signal processing circuit or signal processing apparatus that can be described based on general understanding of the technical field to which the present invention pertains. Also, the received signal processing section 404 can constitute the receiving section according to the present invention.

The received signal processing section 404 blind-detects synchronization signals, the MIB and so on, based on commands from the control section 401, and performs the receiving process. In addition, the received signal processing section 404 estimates channel gain based on reference signals such as DM-RS, CRS and/or others, and demodulates DL signals based on the channel gain estimated.

The received signal processing section 404 outputs the decoded information, acquired through the receiving process, to the control section 401. The received signal processing section 404 outputs, for example, broadcast information, system information, RRC signaling, DCI and so on, to the control section 401. The received signal processing section 404 may output the decoding result of the data to the control section 401. Also, the received signal processing section 404 outputs the received signals, the signals after the receiving process and so on, to the measurement section 405.

The measurement section 405 conducts measurements with respect to the received signals. The measurement section 405 can be constituted by a measurer, a measurement circuit or measurement apparatus that can be described based on general understanding of the technical field to which the present invention pertains.

The measurement section 405 may measure, for example, the received power (for example, RSRP), DL received quality (for example, RSRQ), channel states and so on of the received signals. The measurement results may be output to the control section 401.

(Hardware Structure)

Note that the block diagrams that have been used to describe the above embodiments show blocks in functional units. These functional blocks (components) may be implemented in arbitrary combinations of hardware and/or software. Also, the means for implementing each functional block is not particularly limited. That is, each functional block may be realized by one piece of apparatus that is physically and/or logically aggregated, or may be realized by directly and/or indirectly connecting two or more physically and/or logically separate pieces of apparatus (via wire and/or wireless, for example) and using these multiple pieces of apparatus.

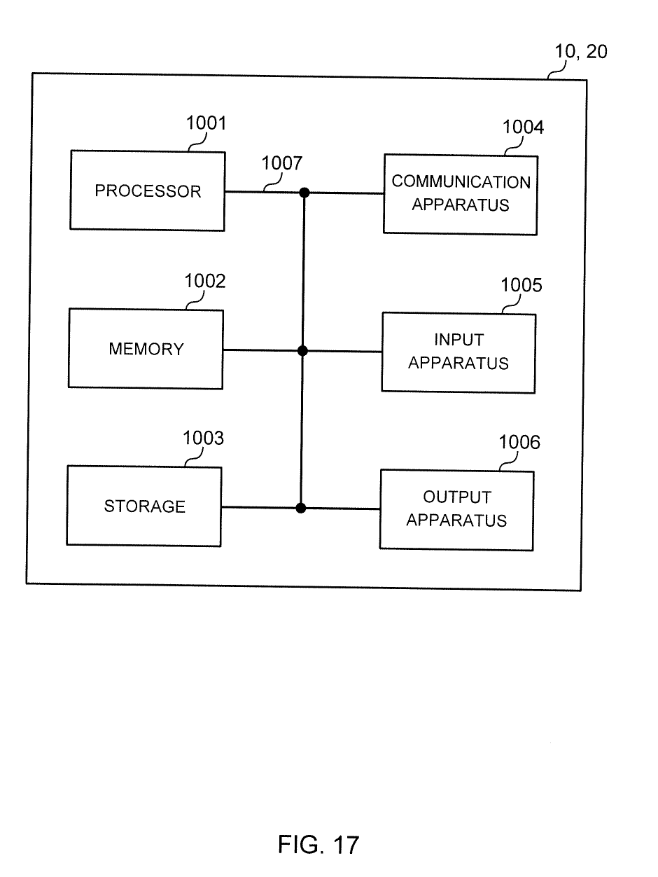

That is, the radio base stations, user terminals and so according to the embodiments of the present invention may function as a computer that executes the processes of the radio communication method of the present invention. FIG. 17 is a diagram to show an example hardware structure of a radio base station and a user terminal according to one embodiment of the present invention. Physically, a radio base station 10 and a user terminal 20, which have been described, may be formed as computer apparatus that includes a processor 1001, a memory 1002, a storage 1003, communication apparatus 1004, input apparatus 1005, output apparatus 1006 and a bus 1007.

Note that, in the following description, the word “apparatus” may be replaced by “circuit,” “device,” “unit” and so on. Note that the hardware structure of a radio base station 10 and a user terminal 20 may be designed to include one or more of each apparatus shown in the drawings, or may be designed not to include part of the apparatus.

For example, although only one processor 1001 is shown, a plurality of processors may be provided. Furthermore, processes may be implemented with one processor, or processes may be implemented either simultaneously or in sequence, or in different manners, on two or more processors. Note that the processor 1001 may be implemented with one or more chips.

Each function of the radio base station 10 and the user terminal 20 is implemented by reading predetermined software (program) on hardware such as the processor 1001 and the memory 1002, and by controlling the calculations in the processor 1001 the communication in the communication apparatus 1004 and the reading and/or writing of data in the memory 1002 and the storage 1003.

The processor 1001 may control the whole computer by, for example, running an operating system. The processor 1001 may be configured with a central processing unit (CPU), which includes interfaces with peripheral apparatus, control apparatus, computing apparatus, a register and so on. For example, the above-described baseband signal processing section 104 (204), call processing section 105 and so on may be implemented by the processor 1001.

Furthermore, the processor 1001 reads programs (program codes), software modules or data, from the storage 1003 and/or the communication apparatus 1004, into the memory 1002, and executes various processes according to these. As for the programs, programs to allow computers to execute at least part of the operations of the above-described embodiments may be used. For example, the control section 401 of the user terminals 20 may be implemented by control programs that are stored in the memory 1002 and that operate on the processor 1001, and other functional blocks may be implemented likewise.

The memory 1002 is a computer-readable recording medium, and may be constituted by, for example, at least one of a ROM (Read Only Memory), an EPROM (Erasable Programmable ROM), an EEPROM (Electrically EPROM), a RAM (Random Access Memory) and/or other appropriate storage media. The memory 1002 may be referred to as a “register,” a “cache,” a “main memory (primary storage apparatus)” and so on. The memory 1002 can store executable programs (program codes), software modules, and the like for implementing the radio communication methods according to embodiments of the present invention.

The storage 1003 is a computer-readable recording medium, and may be constituted by, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk), a removable disk, a hard disk drive, a smart card, a flash memory device (for example, a card, a stick, a key drive, etc.), a magnetic stripe, a database, a server, and/or other appropriate storage media. The storage 1003 may be referred to as “secondary storage apparatus.”

The communication apparatus 1004 is hardware (transmitting/receiving device) for allowing inter-computer communication by using wired and/or wireless networks, and may be referred to as, for example, a “network device,” a “network controller,” a “network card,” a “communication module” and so on. The communication apparatus 1004 may be configured to include a high frequency switch, a duplexer, a filter, a frequency synthesizer and so on in order to realize, for example, frequency division duplex (FDD and/or time division duplex (TDD). For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from the outside (for example, a keyboard, a mouse, a microphone, a switch, a button, a sensor and so on). The output apparatus 1006 is an output device for allowing sending output to the outside (for example, a display, a speaker, an LED (Light Emitting Diode) lamp and so on). Note that the input apparatus 1005 and the output apparatus 1006 may be provided in an integrated structure (for example, a touch panel).

Furthermore, these types of apparatus, including the processor 1001, the memory 1002 and others, are connected by a bus 1007 for communicating information. The bus 1007 may be formed with a single bus, or may be formed with buses that vary between pieces of apparatus.

Also, the radio base station 10 and the user terminal 20 may be structured to include hardware such as a microprocessor, a digital signal processor (DSP), an ASIC (Application-Specific Integrated Circuit), a PLD (Programmable Logic Device), an FPGA (Field Programmable Gate Array) and so on, and part or all of the functional blocks may be implemented by the hardware. For example, the processor 1001 may be implemented with at least one of these pieces of hardware.

(Variations)

Note that the terminology used in this specification and the terminology that is needed to understand this specification may be replaced by other terms that convey the same or similar meanings. For example, “channels” and/or “symbols” may be replaced by “signals (or “signaling”).” Also, “signals” may be “messages.” A reference signal may be abbreviated as an “RS,” and may be referred to as a “pilot,” a “pilot signal” and so on, depending on which standard applies. Furthermore, a “component carrier (CC)” may be referred to as a “cell,” a “frequency carrier,” a “carrier frequency” and so on.

Furthermore, a radio frame may be comprised of one or more periods (frames) in the time domain. Each of one or more periods (frames) constituting a radio frame may be referred to as a “subframe.” Furthermore, a subframe may be comprised of one or more slots in the time domain. Furthermore, a slot may be comprised of one or more symbols (OFDM (Orthogonal Frequency Division Multiplexing) symbols, SC-FDMA (Single Carrier Frequency Division Multiple Access) symbols, and so on) in the time domain.

A radio frame, a subframe, a slot and a symbol all represent the time unit in signal communication. A radio frame, a subframe, a slot and a symbol may be each called by other applicable names. For example, one subframe may be referred to as a “transmission time interval (TTI),” or a plurality of consecutive subframes may be referred to as a “TTI,” and one slot may be referred to as a “TTI.” That is, a subframe and a TTI may be a subframe (1 ms) in existing LTE, may have a shorter period than 1 ms (for example, one to thirteen symbols), or may have a longer period than 1 ms.

Here, a TTI refers to the minimum time unit of scheduling in radio communication, for example. For example, in LTE systems, a radio base station schedules the radio resources (such as the frequency bandwidth and transmission power that can be used in each user terminal) to allocate to each user terminal in TTI units. Note that the definition of TTIs is not limited to this. The TTI may be the transmission time unit of channel-encoded data packets (transport blocks), or may be the unit of processing in scheduling, link adaptation and so on.

A TTI having a time duration of one ms may be referred to as a “normal TTI (TTI in LTE Rel. 8 to 12),” a “long TTI,” a “normal subframe,” a “long subframe,” and so on. A TTI that is shorter than a normal TTI may be referred to as a “shortened TTI,” a “short TTI,” a “shortened subframe,” a “short subframe,” and so on.

A resource block (RB) is the unit of resource allocation in the time domain and the frequency domain, and may include one or a plurality of consecutive subcarriers in the frequency domain. Also, an RB may include one or more symbols in the time domain, and may be one slot, one subframe or one TTI in length. One TTI and one subframe each may be comprised of one or more resource blocks. Note that an RB may be referred to as a “physical resource block (PRB (Physical RB)),” a “PRB pair,” an “RB pair” and so on.

Furthermore, a resource block may be comprised of one or more resource elements (REs). For example, one RE may be a radio resource field of one subcarrier and one symbol.

Note that the structures of radio frames, subframes, slots, symbols and the like described above are merely examples. For example, configurations pertaining to the number of subframes included in a radio frame, the number of slots included in a subframe, the number of symbols and RBs included in a slot, the number of subcarriers included in an RB, the number of symbols in a TTI, the symbol duration, the length of cyclic prefixes (CPs) and so on can be variously changed.

Also, the information and parameters described in this specification may be represented in absolute values or in relative values with respect to predetermined values, or may be represented in other information formats. For example, radio resources may be specified by predetermined indices. In addition, equations to use these parameters and so on may be used, apart from those explicitly disclosed in this specification.

The names used for parameters and so on in this specification are in no respect limiting. For example, since various channels (PUCCH (Physical Uplink Control CHannel), PDCCH (Physical Downlink Control CHannel) and so on) and information elements can be identified by any suitable names, the various names assigned to these individual channels and information elements are in no respect limiting.

The information, signals and/or others described in this specification may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Information, signals and so on can be output from higher layers to lower layers and/or from lower layers to higher layers. Information, signals and so on may be input and output via a number of network nodes.

The information, signals and so on that are input and/or output may be stored in a specific place (for example, a memory), or may be managed using a management table. The information, signals and so on to be input and/or output can be overwritten, updated or appended. The information, signals and so on that are output may be deleted. The information, signals and so on that are input may be transmitted to other pieces of apparatus.

Reporting of information is by no means limited to the aspects/embodiments described in this specification, and other methods may be used as well. For example, reporting of information may be implemented by using physical layer signaling (for example, downlink control information (DCI), uplink control information (UCI) and so on), higher layer signaling (for example, RRC (Radio Resource Control) signaling, broadcast information (the master information block (MIB), system information blocks (SIBs) and so on), MAC (Medium Access Control) signaling and so on), and other signals and/or combinations of these.

Physical layer signaling may be referred to as “L1/L2 (Layer 1/Layer 2) control information (L1/L2 control signals),” “L1 control information (L1 control signal)” and so on. Also, RRC signaling may be referred to as “RRC messages,” and can be, for example, an RRC connection setup message, RRC connection reconfiguration message, and so on. Also, MAC signaling may be reported using, for example, MAC control elements (MAC CEs (Control Elements)).

Also, reporting of predetermined information (for example, reporting of information to the effect that “X holds”) does not necessarily have to be sent explicitly, and can be sent implicitly (by, for example, not reporting this piece of information, or by reporting a different piece of information). Decisions may be made in values represented by one bit (0 or 1), may be made in Boolean values that represent true or false, or may be made by comparing numerical values (for example, comparison against a predetermined value).

Software, whether referred to as “software,” “firmware,” “middleware,” “microcode” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server or other remote sources by using wired technologies (coaxial cables, optical fiber cables, twisted-pair cables, digital subscriber lines (DSL) and so on) and/or wireless technologies (infrared radiation, microwaves and so on), these wired technologies and/or wireless technologies are also included in the definition of communication media.

The terms “system” and “network” as used herein are used interchangeably.

As used herein, the terms “base station (BS),” “radio base station,” “eNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell” and so on.

A base station can accommodate one or more (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads)). The term “cell” or “sector” refers to part or all of the coverage area of a base station and/or a base station subsystem that provides communication services within this coverage.

As used herein, the terms “mobile station (MS)” “user terminal,” “user equipment (UE)” and “terminal” may be used interchangeably. A base station may be referred to as a “fixed station,” “NodeB,” “eNodeB (eNB),” “access point,” “transmission point,” “receiving point,” “femto cell,” “small cell” and so on.

A mobile station may be referred to, by a person skilled in the art, as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client” or some other suitable terms.

Furthermore, the radio base stations in this specification may be interpreted as user terminals. For example, each aspect/embodiment of the present invention may be applied to a structure in which communication between a radio base station and a user terminal is replaced with communication among a plurality of user terminals (D2D (Device-to-Device)). In this case, user terminals 20 may have the functions of the radio base stations 10 described above. In addition, terms such as “uplink” and “downlink” may be interpreted as “side.” For example, an uplink channel may be interpreted as a side channel.

Likewise, the user terminals in this specification may be interpreted as radio base stations. In this case, the radio base stations 10 may have the functions of the user terminals 20 described above.

Certain actions which have been described in this specification to be performed by base station may, in some cases, be performed by higher nodes (upper nodes). In a network consisting of one or more network nodes with base stations, it is clear that various operations that are performed to communicate with terminals can be performed by base stations, one or more network nodes (for example, MMEs (Mobility Management Entities), S-GW (Serving-Gateways), and so on may be possible, but these are not limiting) other than base stations, or combinations of these.

The aspects/embodiments illustrated in this specification may be used individually or in combinations, which may be switched depending on the mode of implementation. The order of processes, sequences, flowcharts and so on that have been used to describe the aspects/embodiments herein may be re-ordered as long as inconsistencies do not arise. For example, although various methods have been illustrated in this specification with various components of steps in exemplary orders, the specific orders that are illustrated herein are by no means limiting.

The aspects/embodiments illustrated in this specification may be applied to systems that use LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR (New Radio), NX (New radio access), FX (Future generation radio access), GSM (registered trademark), (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark) and other adequate radio communication methods, and/or next-generation systems that are enhanced based on these.

The phrase “based on” as used in this specification does not mean “based only on,” unless otherwise specified. In other words, the phrase “based on” means both “based only on” and “based at least on.”

Reference to elements with designations such as “first,” “second” and so on as used herein does not generally limit the number/quantity or order of these elements. These designations are used only for convenience, as a method of distinguishing between two or more elements. In this way, reference to the first and second elements does not imply that only two elements may be employed, or that the first element must precede the second element in some way.

The terms “judge” and “determine” as used herein may encompass a wide variety of actions. For example, to “judge” and “determine” as used herein may be interpreted to mean making judgements and determinations related to calculating, computing, processing, deriving, investigating, looking up (for example, searching a table, a database or some other data structure), ascertaining and so on. Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on. In addition, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

As used herein, the terms “connected” and “coupled,” or any variation of these terms, mean all direct or indirect connections or coupling between two or more elements, and may include the presence of one or more intermediate elements between two elements that are “connected” or “coupled” to each other. The coupling or connection between the elements may be physical, logical or a combination thereof. For example, “connection” may be interpreted as “access.” As used herein, two elements may be considered “connected” or “coupled” to each other by using one or more electrical wires, cables and/or printed electrical connections, and, as a number of non-limiting and non-inclusive examples, by using electromagnetic energy, such as electromagnetic energy having wavelengths in radio frequency regions, microwave regions and/or optical regions (both visible and invisible).

When terms such as “include,” “comprise” and variations of these are used in this specification or in claims, these terms are intended to be inclusive, in a manner similar to the way the term “provide” is used. Furthermore, the term “or” as used in this specification or in claims is intended to be not an exclusive disjunction.

Now, although the present invention has been described in detail above, it should be obvious to a person skilled in the art that the present invention is by no means limited to the embodiments described herein. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

The disclosure of Japanese Patent Application No. 2016-157993, filed on Aug. 10, 2016, including the specification, drawings and abstract, is incorporated herein by reference in its entirety.

1. A user terminal that communicates in a radio communication system where multiple numerologies are configured, the user terminal comprising:
a receiving section that receives system information of each of the numerologies via at least one-broadcast channel; and
a control section that controls reception of the broadcast channel,
wherein the control section controls reception of the broadcast channel that is transmitted in each of the numerologies or that is transmitted selectively in a given numerology.

2. The user terminal according to claim 1, wherein the control section controls reception of a broadcast channel that is transmitted in another numerology, based on an anchor broadcast channel that is transmitted in the given numerology.

3. The user terminal according to claim 1, wherein the control section exerts control to receive the broadcast channel transmitted in each of the numerologies, based on an offset that is configured between a given signal and the broadcast channel.

4. The user terminal according to claim 1, wherein the control section exerts control to receive information including combination of multiple system information of the numerologies is received in the given numerology.

5. The user terminal according to claim 1, wherein the control section exerts control to receive an anchor broadcast channel in the given numerology, and to receive, based on the anchor broadcast channel, a broadcast channel containing system information of another numerology in the given numerology.

6. A radio communication method for a user terminal that communicates in a radio communication system where a plurality of numerologies are configured, the radio communication method comprising:
receiving at least one broadcast channel; and
obtaining system information of each of the numerologies from the broadcast channel received,
wherein the user terminal controls reception of the broadcast channel that is transmitted in each of the numerologies or that is transmitted selectively in a given numerology.
